(19) United States
(12) Patent Application Publication
(10) Pub. No.: US 2005/0283494 A1
(43) Pub. Date: Dec. 22, 2005

(54) Visualizing and manipulating multidimensional OLAP models graphically

(75) Inventors: Nathan Gevaerd Colossi, Sao Paulo (BR); Daniel Martin DeKimpe, La Selva Beach, CA (US); Suzanna Khatchatrian, San Jose, CA (US); Craig Reginald Tomlyn, San Jose, CA (US); Wei Zhou, Pacifica, CA (US)

Correspondence Address: INTERNATIONAL BUSINESS MACHINES CORP;IP LAW, 555 BAILEY AVENUE , J46/G4, SAN JOSE, CA, 95141, US

(73) Assignee: International Business Machines Corporation, Armonk, NY (US)

(21) Appl. No.: 10/874,397

(22) Filed: Jun. 22, 2004

(51) Int. Cl. G06F 17/00

(52) U.S. Cl. 707/102

(57) ABSTRACT

Various embodiments of a method, apparatus and article of manufacture for graphically visualizing and manipulating a multidimensional OLAP model are provided. Data describing a multidimensional model is retrieved. The multidimensional model comprises a plurality of groups. Each group has one or more levels. The levels have a hierarchical order. Sets comprising one or more level indicators are displayed. Each set is side-by-side to at least one other set. Each set is associated with one group of the plurality of groups. The one or more level indicators of each set are associated with the one or more levels of the associated group, respectively. The one or more level indicators of each set are displayed in accordance with the hierarchical order of their associated levels. A visual indicator associated with a subset comprising one or more level indicators of each set is displayed.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

In co-pending application Ser. No. ______, entitled “Model Based Optimization with Focus Regions,” filed on the same date herewith, by Nathan Gevaerd Colossi and Daniel Martin DeKimpe, International Business Machines (IBM) Docket Number SVL920040016US1, assigned to the assignee of the present invention, and incorporated herein by reference in its entirety, there is described various embodiments of focus regions which, in some embodiments, is an optimization slice. Although not limited thereto, some embodiments of the present invention employ an optimization slice.

In co-pending application Ser. No. 10/410,793, entitled “Method, System, and Program for Improving Performance of Database Queries,” filed Apr. 9, 2003, by Nathan Gevaerd Colossi, Daniel Martin DeKimpe, Jason Dere and Steven Sit, assigned to the assignee of the present invention, and incorporated herein by reference in its entirety, there is described various embodiments of a performance advisor. Although not limited thereto, some embodiments of the present invention employ various embodiments of a performance advisor.

In co-pending application Ser. No. 10/325,245, entitled, “System and Method for Automatically Building an OLAP Model in a Relational Database,” filed on Dec. 18, 2002, by Nathan Gevaerd Colossi and Daniel Martin DeKimpe, assigned to the assignee of the present invention, and incorporated herein by reference in its entirety, there is described embodiments of a technique for mapping a SQL query to OLAP meta-data. Although not limited thereto, some embodiments of the present invention employ various embodiments of a technique for mapping a SQL query to OLAP meta-data.

### BACKGROUND OF THE INVENTION

1.0 Field of the Invention

This invention relates to visualizing and manipulating multidimensional online analytical processing (OLAP) models graphically.

2.0 Description of the Related Art

OLAP processing is used to access and analyze data. Business data typically comprises sales, product and financial data over various time periods. Using OLAP, an analyst can explore business results interactively. A dimension is a collection of related attributes of the data values of the OLAP system, for example, product, market, time, channel, scenario and customer. OLAP systems are typically multidimensional. To understand their businesses, business analysts frequently work with data which is aggregated across various business dimensions. This provides analysts with the ability to explore business information in context, for example, sales by product by customer by time, or defects by manufacturing plant by time.

In an OLAP system, dimensional models allow business analysts to interactively explore information across multiple viewpoints at multiple levels of aggregation, also referred to as levels. A dimension typically comprises many levels, and the levels are typically hierarchical. The business data is typically aggregated across various dimensions at various levels to provide different views of the data at different levels of aggregation. The data may be aggregated over various periods of time, by geography, by teams and by product, depending on the type and organization of the business. Aggregated data is commonly referred to as an aggregation. For example, an aggregation may be the sales data for the month of July for a specified product. A slice typically comprises a level from at least a subset of dimensions, and aggregations are typically associated with a slice.

Some OLAP systems sequentially list the dimensions, the hierarchies of a dimension and the levels within the hierarchies for a multidimensional model as follows:

Dimension 1
Hierarchy 1,1
   Level 1,1,1
   . . .
   Level 1,1,x

. . .

Dimension n
Hierarchy n, 1
   Level n,1,1
   . . .
   Level n,1,y
      However, such a list does not easily allow a slice to be displayed and viewed.

Therefore, there is a need for an improved representation of the hierarchical levels of a multidimensional model. This technique should also allow a slice of the multidimensional model to be displayed.

### SUMMARY OF THE INVENTION

To overcome the limitations in the prior art described above, and to overcome other limitations that will become apparent upon reading and understanding the present specification, various embodiments of a method, apparatus and article of manufacture for graphically visualizing and manipulating a multidimensional model are disclosed.

In various embodiments, data describing a multidimensional model is retrieved. The multidimensional model comprises a plurality of groups. Each group has one or more levels. The levels have a hierarchical order. Sets comprising one or more level indicators are displayed. Each set is side-by-side to at least one other set. Each set is associated with one group of the plurality of groups. The one or more level indicators of each set are associated with the one or more levels of the associated group, respectively. The one or more level indicators of each set are displayed in accordance with the hierarchical order of their associated levels. A visual indicator associated with a subset comprising one or more level indicators of each set is displayed.

In some embodiments, the visual indicator is a region indicator. In various embodiments, the subset comprises one level indicator of each group, and the visual indicator comprises one or more lines connecting the level indicators of the subset. In other embodiments, the level indicators of the subset are selected using the graphical multidimensional model.

In this way, an improved technique for graphically visualizing the hierarchical levels of a multidimensional model is provided. In various embodiments, a region or slice of the multidimensional model is graphically displayed. In some embodiments, a user can manipulate the multidimensional model graphically.

### BRIEF DESCRIPTION OF THE DRAWINGS

The teachings of the present invention can be readily understood by considering the following description in conjunction with the accompanying drawings, in which:

FIG. 1 depicts an illustrative computer system which uses various embodiments of the present invention;

FIG. 2 depicts an exemplary star schema implementation of a multidimensional model;

FIG. 3 depicts an exemplary meta-data table;

FIG. 4 depicts an embodiment of a graphical user interface comprising a graphical representation of a multidimensional model with an exemplary slice and region that is displayed by the application on the computer's display of FIG. 1;

FIG. 5A depicts a high level flowchart of an embodiment of graphically displaying a multidimensional model;

FIG. 5B depicts a more-detailed flowchart of an embodiment of graphically displaying a multidimensional model of FIG. 5A;

FIG. 6 depicts another embodiment of a graphical user interface comprising the graphical display of the multidimensional model of FIG. 4 in which multiple slices are displayed;

FIG. 7A depicts a flowchart of an embodiment of a technique to graphically display one or more physical slices on the graphical representation of the multidimensional model of FIG. 6;

FIG. 7B depicts a flowchart of an embodiment of the technique of FIG. 7A to graphically display a region comprising more than one level in at least one dimension on the graphical representation of the multidimensional model of FIG. 6;

FIG. 8 depicts a flowchart of an embodiment of a technique to display data associated with a slice or aggregation on the graphical representation of the multidimensional model of FIG. 6;

FIG. 9 depicts a flowchart of an embodiment of a technique to select a slice and generate aggregations for the selected slice to be aggregated using a graphical representation of the multidimensional model of FIG. 6;

FIG. 10 depicts a flowchart of an embodiment which displays information about a slice on the graphical representation of the multidimensional model prior to generating aggregations;

FIG. 11 depicts another embodiment of a graphical user interface which graphically displays levels referenced by a query on the graphical representation of the multidimensional model of FIG. 6;

FIG. 12 depicts a flowchart of an embodiment of graphically displaying a query using the graphical representation of the multidimensional model of FIG. 11;

FIG. 13 depicts another embodiment of a graphical user interface comprising a graphical representation of a multidimensional model which comprises a graphical representation of a query and physical slice(s) which will be accessed when processing the query;

FIG. 14 depicts a flowchart of an embodiment of graphically displaying how a query would be processed using the graphical representation of the multidimensional model of FIG. 13;

FIGS. 15A and 15B depict flowcharts of an embodiment of the record and playback operations provided by the record and playback buttons, respectively, of the graphical user interface of FIG. 13;

FIG. 16 depicts another embodiment of a graphical user interface comprising a graphical representation of a dimensional model provided by an embodiment of the application of FIG. 1;

FIG. 17 depicts an embodiment of an exemplary table view with a pull down menu of a list box suitable for use in another embodiment of the graphical user interface of FIG. 16;

FIG. 18 depicts another embodiment of a graphical user interface comprising a graphical representation of a multidimensional model with a single optimization slice provided by an embodiment of the application of FIG. 1;

FIG. 19 depicts an embodiment of a graphical user interface comprising a graphical representation of a multidimensional model with multiple optimization slices displayed by an embodiment of the application of FIG. 1;

FIG. 20 depicts another embodiment of a graphical user interface comprising a graphical representation of a multidimensional model with a pull down menu to select the query type in an embodiment of the application of FIG. 1;

FIG. 21 depicts another embodiment of a graphical user interface comprising a graphical representation of a multidimensional model in which a user has selected an optimization slice by using a mouse to enclose the level indicators of the optimization slice within a boundary in an embodiment of the application of FIG. 1;

FIG. 22 depicts an embodiment of a graphical user interface comprising a three-dimensional graphical representation of a multidimensional model displaying three dimensions;

FIG. 23 depicts an embodiment of a graphical user interface comprising a three-dimensional graphical representation of a multidimensional model displaying four dimensions;

FIG. 24 depicts an embodiment of a graphical user interface comprising a three-dimensional graphical representation of a multidimensional model displaying ten dimensions;

FIG. 25 depicts an embodiment of a graphical user interface comprising a three-dimensional graphical representation of a multidimensional model displaying six dimensions and two slices;

FIG. 26 depicts a flowchart of an embodiment of displaying the dimensions of a multidimensional model in three-dimensions;

FIG. 27 depicts a flowchart of displaying slices on a three dimensional multidimensional model;

FIG. 28 depicts an embodiment of a graphical user interface comprising a three-dimensional graphical representation of a multidimensional model displaying six dimensions and one region; and

FIG. 29 depicts a flowchart of an embodiment of displaying a region on a three dimensional multidimensional model.

To facilitate understanding, identical reference numerals have been used, where possible, to designate identical elements that are common to some of the figures.

### DETAILED DESCRIPTION

After considering the following description, those skilled in the art will clearly realize that the teachings of the various embodiments of the present invention can be utilized to visualize and/or manipulate multidimensional OLAP models graphically. In various embodiments, data describing a multidimensional model is retrieved. The multidimensional model has a plurality of groups. Each group has one or more levels. The levels have a hierarchical order. Sets comprising one or more level indicators are displayed. Each set is side-by-side to at least one other set. Each set is associated with one group of the plurality of groups. The one or more level indicators of each set are associated with the one or more levels of the associated group, respectively. The one or more level indicators of each set are displayed in accordance with the hierarchical order of their associated levels. A visual indicator associated with a subset comprising one or more level indicators of each set is displayed.

In some embodiments, one or more slices are graphically displayed on the multidimensional model. In various embodiments, one or more lines serially connect the level indicators associated with the levels of the slice. In some embodiments, one or more regions are graphically displayed on the multidimensional model using a region indicator to indicate the level indicators associated with the levels of the region.

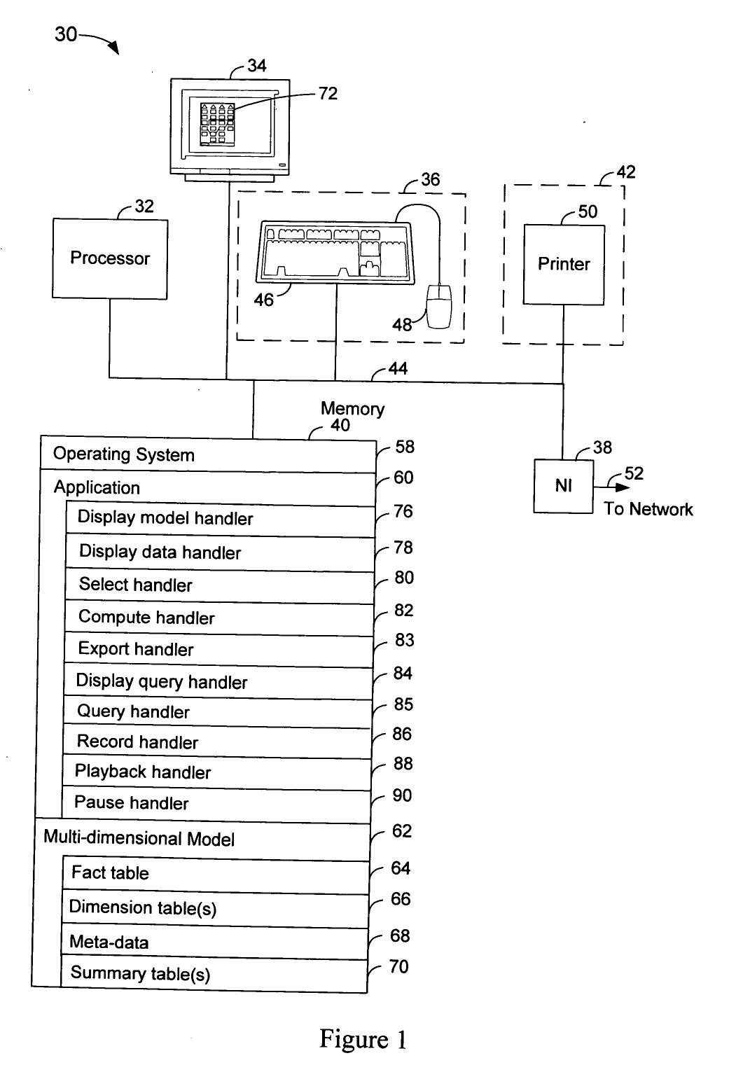

FIG. 1 depicts an illustrative computer system which uses various embodiments of the present invention. The computer system 30 comprises a processor 32, display 34, input interfaces (I/F) 36, communications interface 38, memory 40 and output interface(s) 42, all conventionally coupled by one or more buses 44. The input interfaces 36 comprise a keyboard 46 and a mouse 48. The output interface 42 comprises a printer 50. The communications interface 38 is a network interface (NI) that allows the computer 30 to communicate via a network, such as the Internet. The communications interface 38 may be coupled to a transmission medium 52 such as, a network transmission line, for example twisted pair, coaxial cable or fiber optic cable. In another exemplary embodiment, the communications interface 38 provides a wireless interface, that is, the communications interface 34 uses a wireless transmission medium.

The memory 40 generally comprises different modalities, illustratively semiconductor memory, such as random access memory (RAM), and disk drives. In some embodiments, the memory 40 stores an operating system 58, an application 60 and at least one multidimensional model 62.

The multidimensional model 62 typically comprises a facts table 64, dimension tables 66, meta-data 68 and one or more summary tables 70. The facts table 64, dimension tables 66, meta-data 68 and summary tables 70 will be described in further detail below.

In various embodiments, the application 60 typically displays a graphical user interface comprising a graphical representation 72 of the multidimensional model 62 on the display 34. The application 60 typically comprises at least one handler to manipulate the graphical user interface and respond to events associated with the graphical user interface. In some embodiments, the handlers comprise at least one or a combination of a display model handler 76, a display data handler 78, a select handler 80, a compute handler 82, an export handler 83, a display query handler 84, a query handler 85, a record handler 86, a playback handler 88 and a pause handler 90. The handlers will be described in further detail below.

In some embodiments, the multidimensional model 62 may be remotely located from the application 60 on another computer system and accessed via a network and the network interface 38.

In various embodiments, the specific software instructions, data structures and data that implement various embodiments of the present inventive technique are typically incorporated in the application 60. Generally, an embodiment of the present invention is tangibly embodied in a computer-readable medium, for example, the memory 40 and is comprised of instructions which, when executed by the processor 32, cause the computer system 30 to utilize the present invention. The memory 40 may store the software instructions, data structures and data for any of the operating system 58, application 60, multidimensional model 62, in semiconductor memory, in disk memory, or a combination thereof.

The operating system 58 may be implemented by any conventional operating system, such as z/OS® (Registered Trademark of International Business Machines Corporation), AIX® (Registered Trademark of International Business Machines Corporation), UNIX® (UNIX is a registered trademark of the Open Group in the United States and other countries), WINDOWS® (Registered Trademark of Microsoft Corporation), LINUX® (Registered trademark of Linus Torvalds), Solaris® (Registered trademark of Sun Microsystems Inc.) and HP-UX® (Registered trademark of Hewlett-Packard Development Company, L.P.).

In various embodiments, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier or media. In addition, the software in which various embodiments are implemented may be accessible through the transmission medium, for example, from a server over the network. The article of manufacture in which the code is implemented also encompasses transmission media, such as the network transmission line and wireless transmission media. Thus the article of manufacture also comprises the medium in which the code is embedded. Those skilled in the art will recognize that many modifications may be made to this configuration without departing from the scope of the present invention.

The exemplary computer system illustrated in FIG. 1 is not intended to limit the present invention. Other alternative hardware environments may be used without departing from the scope of the present invention.

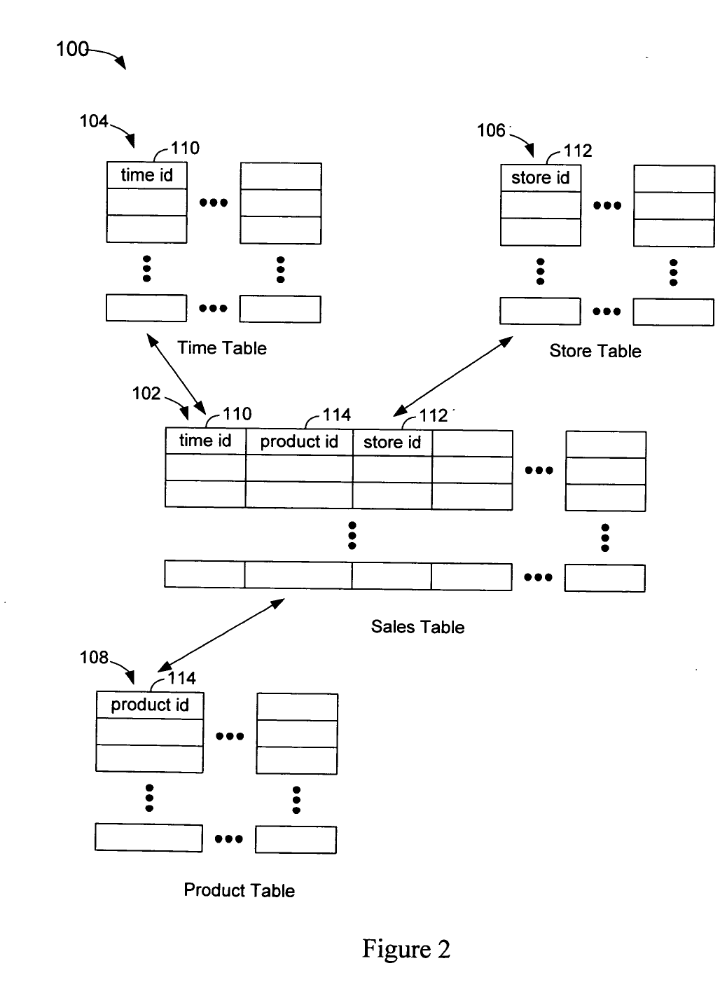

FIG. 2 depicts an exemplary star schema implementation of a multidimensional model 100. In this example, the multidimensional model has three dimensions, time, store and product, and one measure, sales. The sales data is stored in a central facts table 102. The time, store and product tables 104, 106 and 108, respectively, store additional data that is associated with the sales data in the facts table 102. For example, the store table 106 may store information identifying each store associated with the sales data, such as the name and location of the store. The time table 104 may store information associated with the timing of the sales data such as day, month and year. The product table 108 may store information describing the products sold. In the star schema, the time, store and product tables 104, 106 and 108, respectively, are joined to the sales table 102 based on a time identifier (id) 110, a product id 112, and a store id 114, respectively.

The measures may be distributive or non-distributive. For distributive measures, higher aggregations may be derived from lower level aggregations. For example, annual sales volume may be computed as the sum of the monthly sales volume for twelve months, rather than from base data which may store individual sales at the daily level. For non-distributive measures, each level of aggregation is computed from the lowest or base level, and cannot be derived from lower level aggregations. Summary tables 70 (FIG. 1) store pre-computed aggregations so that the data may be accessed quickly.

In various embodiments, the meta-data 68 (FIG. 1) describes the data organization in the dimension, facts and summary tables. The meta-data 68 (FIG. 1) is typically stored in one or more separate tables. The meta-data 68 (FIG. 1) describes the dimensions and the hierarchy, that is, the relationship of the levels within the dimension. The hierarchy is used to aggregate data for and to navigate a dimension. In some embodiments, each dimension has a corresponding hierarchy with defined levels. The meta-data 68 (FIG. 1) also defines various measures contained in the fact table.

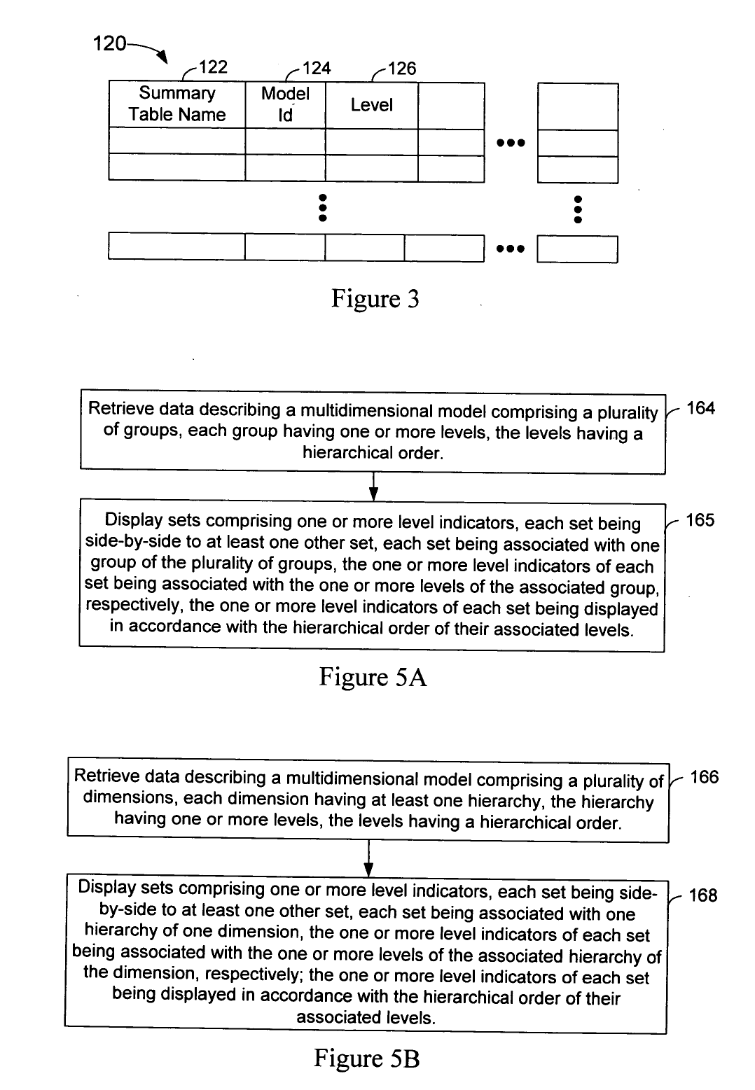

FIG. 3 depicts an illustrative meta-data table 120. The meta-data table 120 associates a summary table with a model identifier and levels. The meta-data table 120 comprises a summary table name column 122, a model identifier (Id) column 124 and a level column 126. The summary table name column 122 stores the name of a summary table. The model identifier 124 associates the summary table with a model. In various embodiments, the level column 126 contains the names of the aggregation levels stored in the summary table. In some embodiments, the level column 126 references one or more other tables that contain information about the levels.

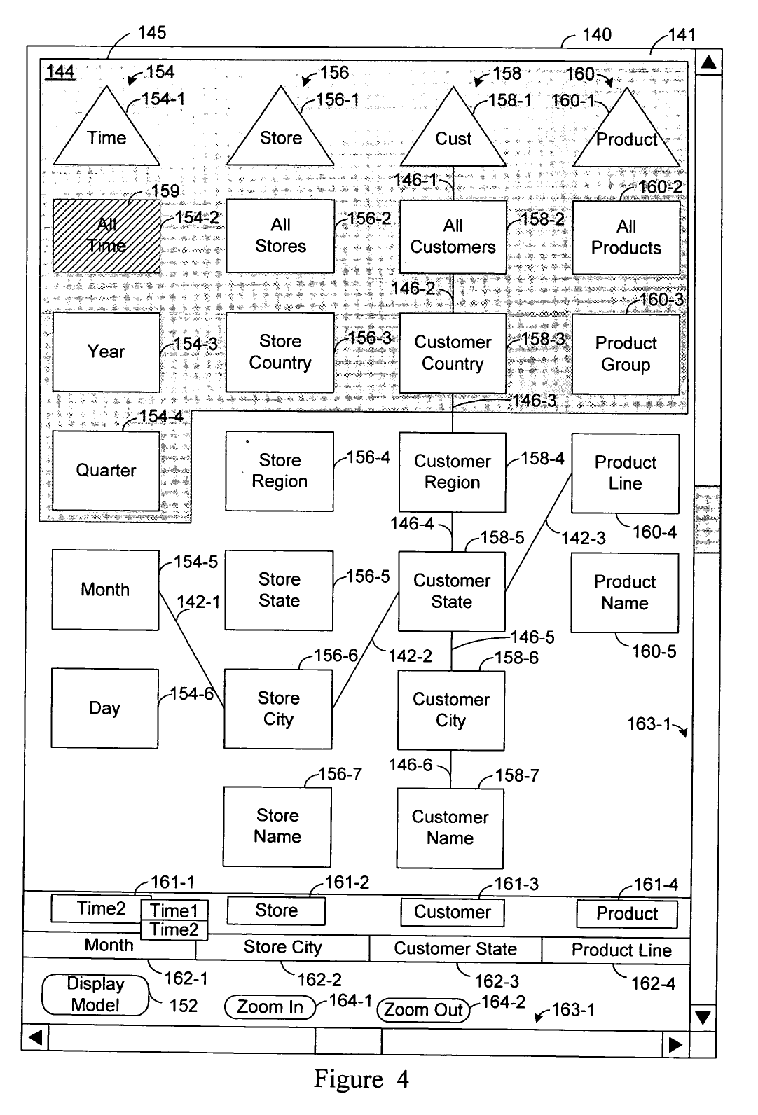

FIG. 4 depicts an embodiment of a graphical user interface 140 comprising a graphical representation 141 of a multidimensional model that is displayed on the computer's display 34 (FIG. 1) with an exemplary slice 142 and region 144. In various embodiments, the graphical user interface 140 is a window, which in some embodiments, can be resized. In some embodiments, when a display model button 152 is activated, the graphical representation 140 is displayed. In the graphical representation of the multidimensional model, each column 154, 156, 158 and 160 represents a hierarchy in a dimension. Headers, such as triangles 154-1, 156-1, 158-1 and 160-1, contain the dimension name. A top level indicator, that is a top block, 154-2, 156-2, 158-2 and 160-2 of each column represents a top or “All” level that represents an aggregation of all the base level data of one or more measures for that dimension. In some embodiments, the top level indicator 154-2, 156-2, 158-2 and 160-2 has visual indicia, for example, shading, a pattern 159 or color, to distinguish it from the level indicators below 154-3 to 154-6, 156-3 to 156-7, 158-3 to 158-7, and 160-3 to 160-5, when there is no explicit corresponding level attribute for the top level. In other embodiments, the top level indicator 154-2, 156-2, 158-2 and 160-2 does not have distinguishing visual indicia. The other level indicators in the column represent levels that were identified from the meta-data. For example, the time dimension has year, quarter, month and day levels, which are associated with level indicators 154-3, 154-4, 154-5 and 154-6, respectively. In some embodiments, the level indicators 154-2 to 154-6, 156-2 to 156-7, 158-2 to 158-7 an 160-2 to 160-5 contain the name of their respective level.

The level indicators are not meant to be limited to blocks. In various embodiments, level indicators comprise one or more graphic elements. The graphic elements comprise one or any combination of a line, a graphical object, text, image or icon. For example, the graphical object may be at least one of a line, polygon, circle, ellipse, or other shape. In some embodiments, different dimensions or hierarchies are associated with visually distinct level indicators representing that dimension or hierarchy, respectively.

The header is not meant to be limited to a triangle. In various embodiments, the header may comprise one or more graphic elements.

The header and level indicators for a dimension are typically substantially aligned vertically. In an alternate embodiment, the header and level indicators are substantially aligned horizontally. In some embodiments, the header and level indicators are substantially aligned along an axis. In yet other embodiments, the header and level indicators are aligned neither vertically nor horizontally but at an angle. In yet other embodiments, perspective is applied to the alignment of the header and level indicators.

The order of the level indicators reflects the hierarchy. For distributive measures or data, the order of the level indicators also reflects how data may be aggregated. For example, in the time hierarchy 154, daily data is aggregated to obtain monthly data, monthly data is aggregated to obtain quarterly data, quarterly data is aggregated to obtain yearly data, and yearly data is aggregated to all time data. Typically, the physical data, also referred to as base level data, corresponds to the bottom level indicator in each hierarchy, for example, day 154-6, store name 156-7, customer name 158-7 and product name 160-5. The data associated with the other levels is calculated from the physical data.

The dimensions or hierarchies are typically displayed side-by-side. As shown in FIG. 4, the dimensions or hierarchies represented by columns 154, 156, 158 and 160, are side-by-side. In various embodiments, the level indicators associated with the different dimensions or hierarchies are displayed side-by-side, and in some embodiments, are aligned. In other embodiments, the level indicators from different dimensions or hierarchies are not aligned with each other. In some embodiments, the dimensions or hierarchies are spaced apart from each other. In various embodiments, the top levels of each dimension or hierarchy are aligned. In other embodiments, the top levels of each dimension or hierarchy are not aligned. When a dimension has multiple hierarchies, the distance between the level indicators of the hierarchies of the same dimension is less than the distance between the level indicators of different dimensions.

A dimensional model may have a large number of possible slices. A logical slice does not contain pre-computed aggregated data. A physical slice contains pre-computed aggregated data or is a slice that comprises all the base levels. Typically, a subset of all the possible slices are physical slices. The data for the logical slices is aggregated dynamically when a query is executed.

In various embodiments, the entire multidimensional space can be thought of as a collection of slices where a slice comprises one level in one hierarchy from each dimension of a dimensional model. In the dimensional model of FIG. 4, there are 720 possible slices. The number of slices is equal to the product of the number of levels in the time dimension (five), the number of levels in the store dimension (six), the number of levels in the customer dimension (six), and the number of levels in the product dimension (four). In FIG. 4, the exemplary slice 142 represents an aggregation of the month, store city, customer state and product line levels, 154-5, 156-6, 158-5 and 160-4, respectively, for one or more measures. The slice 142 is represented by three lines 142-1, 142-2 and 142-3, also referred to as slice indicators, that serially interconnect the level indicators associated with the levels of the slice. In various embodiments, the slice indicator is a special type of region indicator.

A region comprises one or more levels from each dimension of the multidimensional model. The levels may be contiguous or non-contiguous. In some embodiments, a region, such as region 144, comprises one or more contiguous levels from each dimension. In other embodiments, the levels may not be contiguous. For example, a region may comprise the all time and quarter levels in the time dimension, and the StoreCountry, All Customers, and the Product Group. In various embodiments, when a region comprises a single level from the dimensions of the multidimensional model, that region is also referred to as a slice.

A user of an OLAP system typically works with a subset of the multidimensional space. The subset can be a single slice 142 or a collection of slices. In various embodiments, a region 144 of contiguous slices is used. The region 144 comprises all possible slices of the levels within the region. In some embodiments, the region indicator is a line 145. In various embodiments, the region indicator may be the area within the line 145 to which a distinctive color (grayed area), shading pattern, or other distinctive visual indicia is applied. In other embodiments, the region indicator comprises only the line 145 without other distinguishing visual indicia. In some embodiments, the region is a slice and the region indicator indicates the slice, that is, the region indicator indicates the level indicators associated with the levels of the slice.

The slice and the region can be used to represent the state of the multidimensional model or be used to allow the user to specify information about the multidimensional model to input to the application. In some embodiments, the user can define a slice by selecting a level indicator in each dimension. In other embodiments, the user can define a region by selecting level indicators. Alternately, the user can use the mouse to position a cursor to define a region encompassing a set of level indicators to select the associated levels.

In FIG. 4, the multidimensional model has one hierarchy per dimension. In other embodiments, a dimension may have multiple hierarchies. These hierarchies may correspond to a subset of the multidimensional model. In this embodiment, only one hierarchy per dimension is visible. In some embodiments, graphical controls, such as a set of boxes 161 and 162, are provided so that the user can select the hierarchies and levels, respectively, to display. A drop-down box 161-1, 161-2, 161-3 and 161-4 is provided for each dimension to allow the user to select the hierarchy for that dimension. In FIG. 4, the time dimension has two hierarchies, Time1 and Time2, and the Time2 hierarchy is selected. For example, when the user clicks on drop-down box 161-1, the names of the two hierarchies, Time1 and Time2, are displayed for the user to select from. A list box 162-1, 162-2, 162-3 and 162-4 is provided to select a level within the selected hierarchy to define a slice 142. For example, in the Time2 hierarchy (161-1), the month level is selected as indicated by list box 162-1. In the Store hierarchy (161-2), the Store City level is selected as indicated by list box 162-2. In the Customer hierarchy (161-3), the Customer State level is selected as indicated by list box 162-3. In the Product hierarchy (161-4), the Product Line level is selected as indicated by list box 162-4. In some embodiments, the list box is a drop-down box. When a user clicks on a list box, a drop down box which comprises the names of the levels of the hierarchy is displayed to allow a user to select one of the levels. The name of the selected level is displayed in the list box.

In an alternate embodiment, all hierarchies for a dimension are displayed and levels from multiple hierarchies may be selected. In another embodiment, all hierarchies for a dimension are displayed but a user can only select a level from a single hierarchy of the dimension.

In some embodiments, vertical and horizontal scrollbars, 163 and 164, respectively, allow a user to scroll the graphical representation of the multidimensional model. In some embodiments, when the size of the graphical representation of the multidimensional model is larger than the amount of space available for display, that is, a portion of the levels from at least one dimension and/or a subset of all the dimensions can be displayed, vertical and/or horizontal scrollbars, 163-1 and 163-2, respectively, are provided. In some embodiments, a user can activate a zoom-in button 164-1 or a zoom-out button 164-2 to decrease or increase, respectively, the number of dimensions or hierarchies, and/or levels that are displayed within a viewable area of the window.

In another embodiment, dimension lines 146-1 to 146-6 connect the header and level indicators of a hierarchy or dimension. Alternately, the dimension lines 146-1 to 145-6 only connect the level indicators of a hierarchy or dimension. In another embodiment, the dimension lines are between the header and/or level indicators but not connected to the header and level indicators.

FIG. 4 has been described with respect to a dimensional model that has dimensions and hierarchies. In an alternate embodiment, each column 154, 156, 158 and 160 represents a dimension, rather than a hierarchy within a dimension. In another alternate embodiment, for those OLAP systems that do not use dimensions, each column 154, 156, 158 and 160 represents a hierarchy, and in various embodiments, the hierarchy is also treated like a dimension. In yet another alternate embodiment, for those OLAP systems which have dimensions but no hierarchies, a hierarchy may be implied for a dimension.

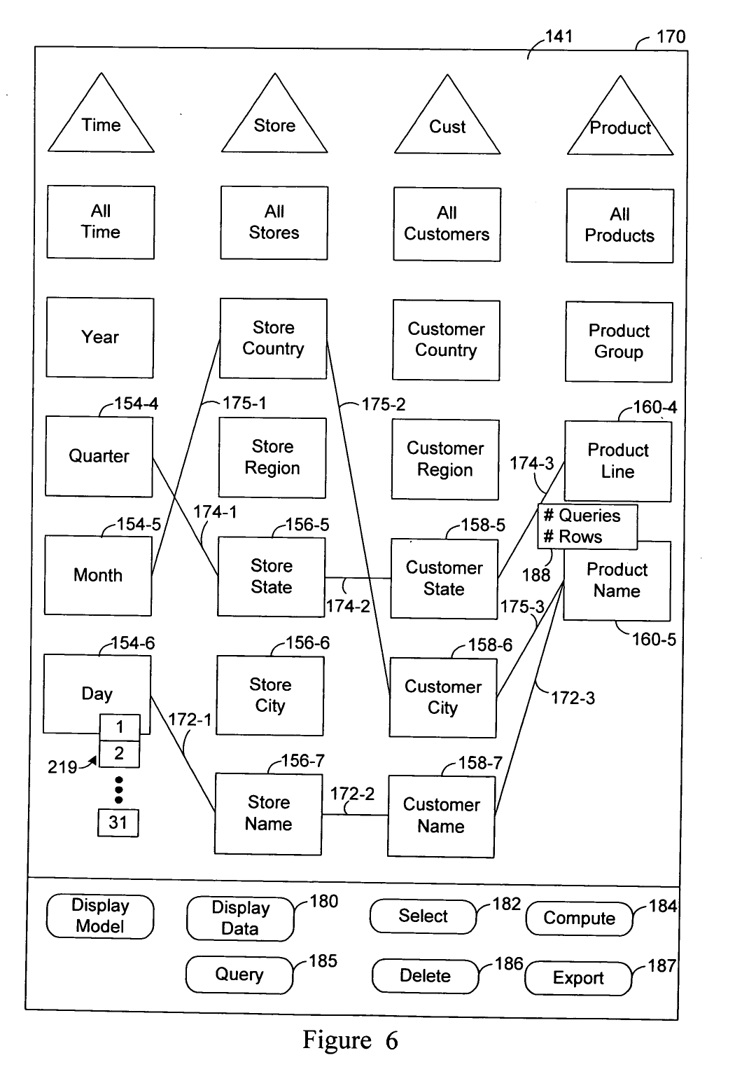

In various embodiments, when the display model button 62 is activated, the graphical representation of the multidimensional model 140, without slices or regions, is displayed. In some embodiments, when the display model button 62 is activated, the display model handler 76 of FIG. 1 is invoked; the display model handler 76 of FIG. 1 implements the flowchart of FIG. 5A, and, in other embodiments, FIG. 6B.

FIG. 5A depicts a high-level flowchart of an embodiment of graphically displaying a multidimensional model on the computer's display. In step 164, data describing a multidimensional model is retrieved. The multidimensional model comprises a plurality of groups. Each group has one or more levels. The levels have a hierarchical order. In step 165, sets comprising one or more level indicators are displayed. Each set is side-by-side to at least one other set. Each set is associated with one group of the plurality of groups. The one or more level indicators of each set are associated with the one or more levels of the associated group, respectively. The one or more level indicators of each set are displayed in accordance with the hierarchical order of their associated levels. In various embodiments, a group is associated with only one set, and a set is associated with only one group,

In various embodiments, a group is a dimension. In other embodiments, a group is a hierarchy. In yet other embodiments, a group is a hierarchy of a dimension having one or more hierarchies. In various embodiments, a dimension has multiple hierarchies.

In some embodiments, the multidimensional model is a cube model. In various embodiments, the multidimensional model is a cube of a cube model. In other embodiments, the multidimensional model is a metaoutline, and, in yet other embodiments, a universe. However, the present invention is not meant to be limited to a cube model, cube, metaoutline and universe and may be used with other types of multidimensional models.

Referring also to FIG. 4, exemplary sets comprising one or more level indicators will now be described. In this example, the group refers to a hierarchy of a dimension. For example, the level indicators 154-2, 154-3, 154-4, 154-5 and 154-6 associated with the hierarchy of the time dimension in column 154, form one set. The level indicators 156-2, 156-3, 156-4, 156-5, 156-6 and 156-7 associated with the hierarchy of the store dimension in column 156, form another set. In various embodiments, distinct visual indicia are displayed to indicate that the level indicators are associated with a set. As shown in FIG. 4, the distinct visual indicia may comprise one or more lines 146-2 to 146-6 connecting the level indicators of a set. In other embodiments, the visual indicia may comprise a distinct color or pattern applied behind the level indicators of a set, or alternately, a line encompassing the level indicators of a set which has a distinct visual appearance from a line associated with a region indicator. The sets are displayed side-by-side. In FIG. 4, the level indicators of the different sets are aligned. In other embodiments, the level indicators of different sets may not be aligned.

FIG. 5B depicts a more-detailed flowchart of an embodiment of graphically displaying a multidimensional model on the computer's display of FIG. 5A for a multidimensional model in which a dimension can have multiple hierarchies. In step 166, data describing a multidimensional model comprising a plurality of dimensions is retrieved. The retrieved data is typically meta-data. Each dimension has at least one hierarchy. The hierarchy has one or more levels. The levels have a hierarchical order. In various embodiments, the retrieved meta-data directly describes the dimensions, the levels and the hierarchy. In some embodiments, at least a portion of the meta-data describing the dimensions, the levels and the hierarchy is derived from other meta-data describing the multi-dimensional model, such as the system catalog.

In step 168, sets comprising one or more level indicators are displayed. Each set is side-by-side to at least one other set. Each set is associated with a hierarchy of one dimension of the plurality of dimensions. The one or more level indicators of each set are associated with the one or more levels of the associated hierarchies of the dimensions, respectively. The one or more level indicators of each set are displayed in accordance with the hierarchical order of their associated levels.

In another embodiment, the flowchart of FIG. 5B can also be modified for use with a dimension which has no hierarchy. In this embodiment, in step 166, data describing a multidimensional model is retrieved. The retrieved data is typically meta-data. The multidimensional model has meta-data for a plurality of dimensions. the dimensions have one or more levels. A hierarchical order is implied. In step 168, sets comprising one or more level indicators are displayed. Each set is side-by-side to at least one other set. Each set is associated with one dimension of the plurality of dimensions. The one or more level indicators of each set are associated with the one or more levels of the associated dimension, respectively. The one or more level indicators of each set are displayed in accordance with the hierarchical order of their associated levels.

In yet another embodiment, the flowchart of FIG. 5B can also be modified for use with multidimensional model which has no dimensions, but only hierarchies. In this embodiment, in step 166, data describing a multidimensional model is retrieved. The retrieved data is typically meta-data. The multidimensional model has meta-data for a plurality of hierarchies. The hierarchies have one or more levels. For each hierarchy, the levels have a hierarchical order. In step 168, sets comprising one or more level indicators are displayed. Each set is side-by-side to at least one other set. Each set is associated with one hierarchy of the plurality of hierarchies. The one or more level indicators of each set are associated with the one or more levels of the associated hierarchy, respectively. The one or more level indicators of each set are displayed in accordance with the hierarchical order of their associated levels.

FIG. 6 depicts another embodiment of a graphical user interface 170 comprising the graphical representation of the multidimensional model 141 of FIG. 4 in which multiple physical slices are displayed. A first or bottom slice 172 represents the base data for the dimensional model and comprises the day, store name, customer name and product name levels, which are associated with level indicators 154-6, 156-7, 158-7 and 160-5, respectively. The bottom slice 172 is represented by three line segments 172-1, 172-2 and 172-3.

In OLAP systems, some aggregations are typically pre-computed to improve the speed of executing queries. A second slice 174 represents a set of pre-computed aggregations of the base data and contains the quarter, store state, customer state and product line levels, which are associated with level indicators 154-4, 156-5, 158-5 and 160-4, respectively. The second slice 174 is represented by three line segments 174-1, 174-2 and 174-3. A third slice 175 is represented by three line segments 175-1, 175-2 and 175-3. The third slice 175 illustrates that slices can cross between dimensions. In various embodiments, each slice is displayed with visually distinct indicia such as color or shading. In some embodiments, the lines and/or level indicators associated with the base data slice are visually distinguished from the lines and/or indicators associated with a slice or slices that comprise aggregations.

The graphical user interface of FIG. 6 further comprises a display data button (Display Data) 180, a select button (Select) 182, a compute button (Compute) 184, a query button (Query) 185, a delete button (Delete) 186 and an export (Export) button 187. When the display data button 180 is activated, the physical slices 172, 174 and 175 of the dimensional model are displayed. More generally, when the dimensional model contains a region, the region, for example region 144 (FIG. 4), will be displayed. When the select button 182 is activated, a user can define a region or slice by selecting, that is, clicking on, level indicators. When the select button 182 is deactivated, meta-data describing the levels of the defined region or slice is stored. When the compute button 184 is activated, aggregations are computed in accordance with the defined region or slice. In various embodiments, a slice can be selected by clicking on a line 174 associated with the slice, and a region can be selected by clicking on a region indicator 145 (FIG. 4). When the query button 185 is activated, a query is performed based on the selected region or slice. When the delete button 186 is activated, the selected region or slice is removed from the display. In some embodiments, activating the delete button 186 also causes any physical aggregations associated with the selected region or slice to be deleted. When the export button 187 is activated, the selected slice or slices of the selected region are exported.

In other embodiments, when the user clicks on a line 174-3 associated with a slice or a region indicator, additional information about the slice or region, respectively, is displayed in a text box 188. The additional information comprises the number of queries that referenced the slice or region (# Queries) and/or the number of rows in the slice or region (# Rows).

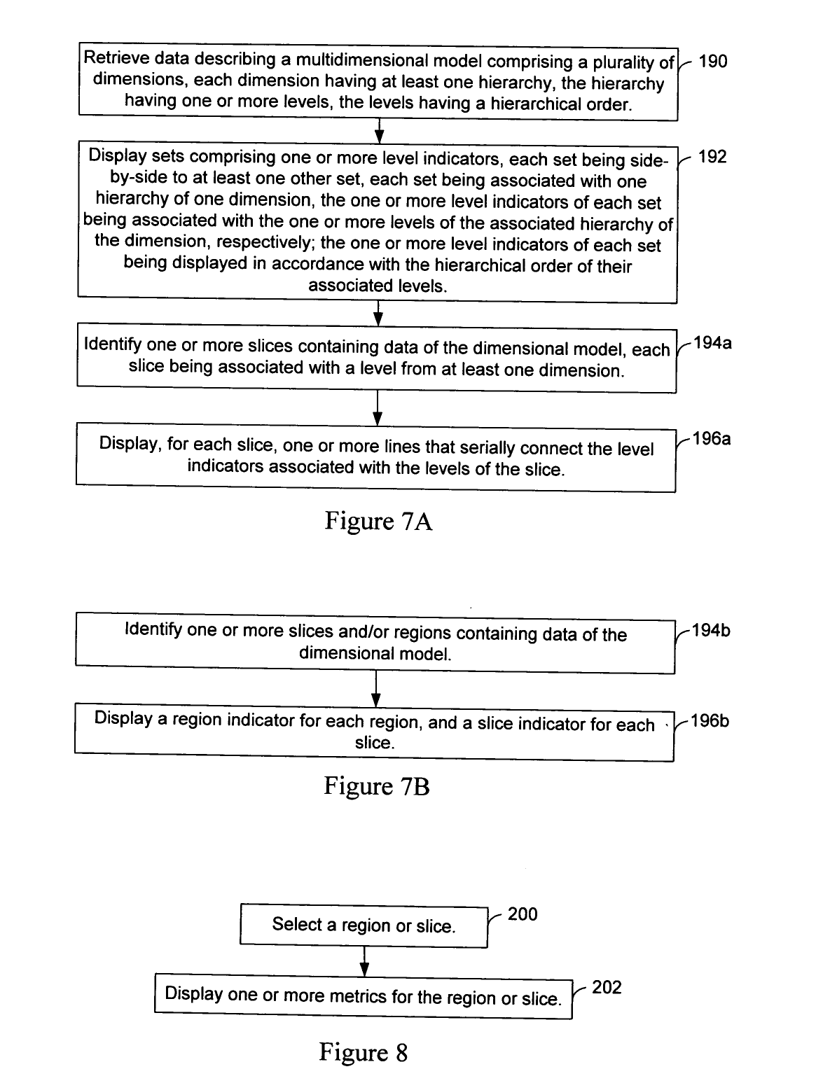

FIG. 7A depicts a flowchart of an embodiment of a technique to graphically display one or more physical slices of the dimensional model on the computer's display. Steps 190 and 192 of FIG. 7A are the same as steps 166 and 168 of FIG. 5B and will not be further described.

In step 194a, one or more slices containing data of the multi-dimensional model are identified. Each slice is associated with a level from at least one dimension. In some embodiments, the application accesses the meta-data to determine the summary tables for a model and identifies one or more the slices and the level information for the slices from the summary tables. In other embodiments, the application identifies the slices and the level information for the slices by deriving the information from the summary tables and the system catalog of the database management system. In step 196a, for each slice, one or more lines that serially connect the level indicators associated with the levels of the slice are displayed. In other embodiments, a region indicator is used to indicate a slice, rather than using one or more lines that serially connect the level indicators associated with the levels of the slice.

In another embodiment, as shown in FIG. 7B, steps 194a and 196a of the flowchart of FIG. 7A are modified for use with regions comprising more than one level in at least one dimension. Steps 194b and 196b are modified embodiments of steps 194a and 196a, respectively, of FIG. 7A. In step 194b, one or more slices and/or regions containing data of the multi-dimensional model are identified. In some embodiments, the application accesses the meta-data to determine the summary tables for a model and identifies one or more slices and/or regions and the level information for the regions from the summary tables. In other embodiments, the application identifies one or more slices and/or regions and the level information for the slices and/or regions by deriving the information from the summary tables and the system catalog of the database management system. In step 196b, a region indicator is displayed for each region, and a slice indicator is displayed for each slice. In other embodiments, a region indicator is also used for slices. Both region indicators and slice indicators are visual indicators.

In various embodiments, the technique of the flowchart of FIGS. 7A, or alternately, FIG. 7B, is implemented in the display data handler 78 of FIG. 1. In an alternate embodiment, steps 194a and 196a or steps 194b and 196b, and not steps 190 and 192, are implemented in the display data handler 78 of FIG. 1.

FIG. 8 depicts a flowchart of an embodiment of a technique to display data associated with a slice or region on the graphical representation of the multidimensional model of FIG. 6. In step 200, a user selects a region or a slice that is displayed. In some embodiments, when a slice is displayed, the user selects the slice by clicking on a line segment 174 (FIG. 6) of the slice, and when a region is displayed, the user selects the region by clicking on a region indicator 145 (FIG. 4). In step 202, the application displays one or more metrics 188 (FIG. 6) for the region or slice. The metrics comprise at least one or any combination of the number of queries that accessed the region or slice, the number of rows and the width of the region or slice, the frequency of access of the region or slice and/or a percentage representing the usage of the aggregations associated with a region or slice based on a workload. The workload typically represents a total number of aggregations accessed for a predetermined period of time.

In other embodiments, the application uses graphical indicia such as shading and color to illustrate the performance characteristics of the multidimensional model. A first color may be applied to the level indicators, lines of the frequently accessed slices and/or region indicators; and a second color, different from the first color, may be applied to the other level indicators, lines and region indicators. In some embodiments, a slice or region is considered to be frequently accessed if the number of queries that request aggregations of that slice or region in a predetermined period of time exceeds a predetermined access-frequency threshold.

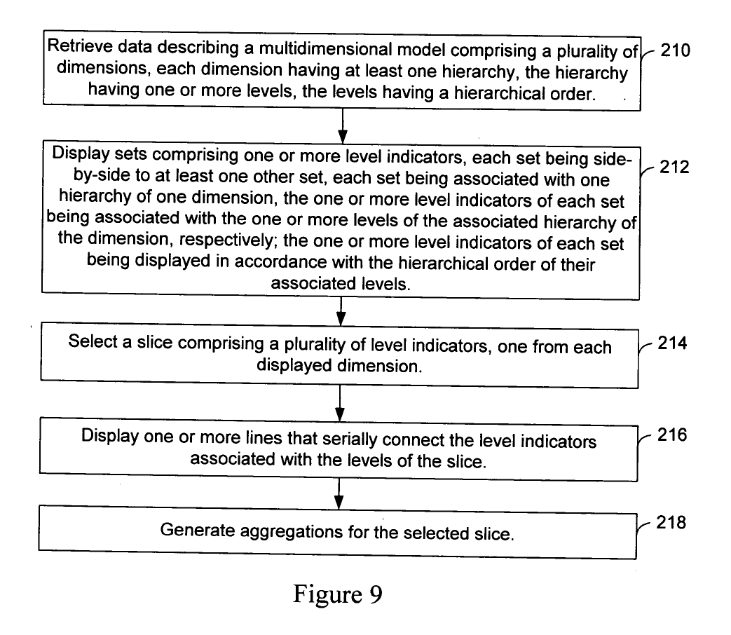

FIG. 9 depicts a flowchart of an embodiment of a technique to select a slice and generate aggregations for the selected slice using the graphical representation of the multidimensional model of FIG. 6. Steps 210 and 212 of FIG. 9 are the same as steps 166 and 168 of FIG. 5B and will not be further described.

In step 214, a slice, comprising a plurality of level indicators, one from each displayed dimension, is selected. Each level indicator is associated with a level from a dimension. In some embodiments, a slice is selected by sequentially clicking on a level indicator in each displayed dimension. Alternately, a user may click on a select button 182 (FIG. 6) and then click on a level indicator in each dimension to select a slice. In another embodiment, referring also to FIG. 4, each displayed dimension is associated with a list box that when clicked on displays the levels of that dimension to allow a user to select a level. A user may also select a slice by selecting a level from the listbox for each displayed dimension.

In step 216, one or more lines that serially connect the level indicators associated with the levels of the slice are displayed. In some embodiments, distinguishing indicia is applied to the level indicators associated with the selected slice. The distinguishing indicia comprise color, highlighting, changing the size of the level indicator, changing the shape of the level indicator, and causing the level indicator to blink. In other embodiments, a region indicator is used to indicate a slice, rather than using one or more lines.

In step 218, aggregations are generated for each selected slice. In various embodiments, a query is generated to build the aggregations associated with the levels represented by the level indicators of the selected slice. In one embodiment, aggregations are built for all the measures defined in the model. In another embodiment, a user may select the measures for which to generate aggregations. For example, another list box may be provided to allow a user to select the measures. In some embodiments, a user may click on the compute button 184 (FIG. 6) to cause the aggregations to be generated for each selected slice, or alternately, region.

In another embodiment, the flowchart of FIG. 9 is modified for use with regions. In step 214, a user may select a region to select all the slices associated with that region. In some embodiments, a region is selected by clicking on level indicators. Alternately, a user may click on a select button 182 (FIG. 6) and then click on level indicators in each dimension to select a region. In step 216, a region indicator is displayed to indicate the region. In step 218, aggregations are generated for all the slices of the selected region. In various embodiments, the individual slices associated with the selected region are not shown.

In yet another embodiment, steps 214 and 216 are repeated to select multiple slices, multiple regions, or a combination of one or more slices and one or more regions. In step 218, aggregations are generated for all the selected slices and regions.

In various embodiments, steps 214 and 216 of FIG. 9 are implemented in the select handler 80 of FIG. 1. When the select button 182 (FIG. 6) is activated, the select handler 80 (FIG. 1) is invoked. In some embodiments, step 218 is implemented in the compute handler 82 of FIG. 1. When the compute button 184 (FIG. 6) is activated, the compute handler 82 (FIG. 1) is invoked.

In another embodiment, a query to retrieve data from the multidimensional model is generated based on the selected slice. In this embodiment, when a slice is selected and when the user clicks on a level indicator of the selected slice, a list of selection parameters is displayed. For example, when the day level 154-6 (FIG. 6) is clicked on a list 219 (FIG. 6) of days is displayed for the user to select from. When the query button 185 (FIG. 6) is activated, a query is generated based on the selected slice and the selection parameters. Alternately, a region may be selected, and a query is generated based on the region, and selection parameters, if any.

In yet another embodiment, the data and meta-data corresponding to the selected slice, slices or region are exported. When the export button 187 (FIG. 6) is activated, the export handler 83 (FIG. 1) is invoked. The export handler 83 (FIG. 1) exports the aggregations, and in some embodiments the meta-data associated with the selected slice, slices or region.

In another embodiment, the application suggests the slices to be used to produce aggregations, rather than a user selecting slices in step 214. U.S. patent application, Ser. No. 10/410,793, filed Apr. 9, 2003, entitled “Method, System, and Program for Improving Performance of Database Queries,” to Nathan Gevaerd Colossi et al. describes embodiments of an application, a performance advisor, that suggests slices to be used to produce aggregations.

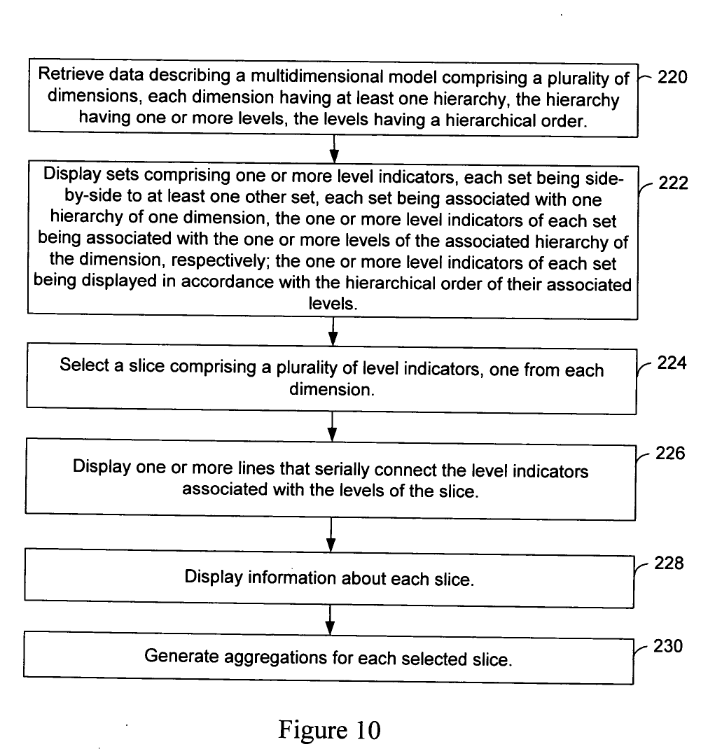

FIG. 10 depicts a flowchart of an embodiment which provides information about a slice prior to generating aggregations. Steps 220 to 226 of the flowchart of FIG. 10 are the same as steps 210 to 216 of the flowchart of FIG. 9 and will not be further described.

In step 228, information is displayed about the slice. Generating aggregations can improve query performance. However, it takes time and disk space to generate aggregations. In various embodiments, the application provides information such as estimates of the aggregation sizes and an amount of time to build the aggregations for the slice. In an alternate embodiment, information such as the amount of time to generate aggregations and amount of disk space to store the aggregations is displayed for a region. At this point, a user could remove a slice or region by, for example, clicking on the displayed slice or region indicator and activating the delete button 186 (FIG. 6). In step 230, aggregations are generated for the selected slices, or alternately, a region. In some embodiments, step 230 is implemented in the compute handler 82 of FIG. 1.

Queries can refer to data from any combination of levels. For example, a query could obtain monthly sales data for product lines by state. Queries against multidimensional models can obtain aggregated data from one or more slices. In various embodiments, a query is represented graphically by showing the levels referenced by the query.

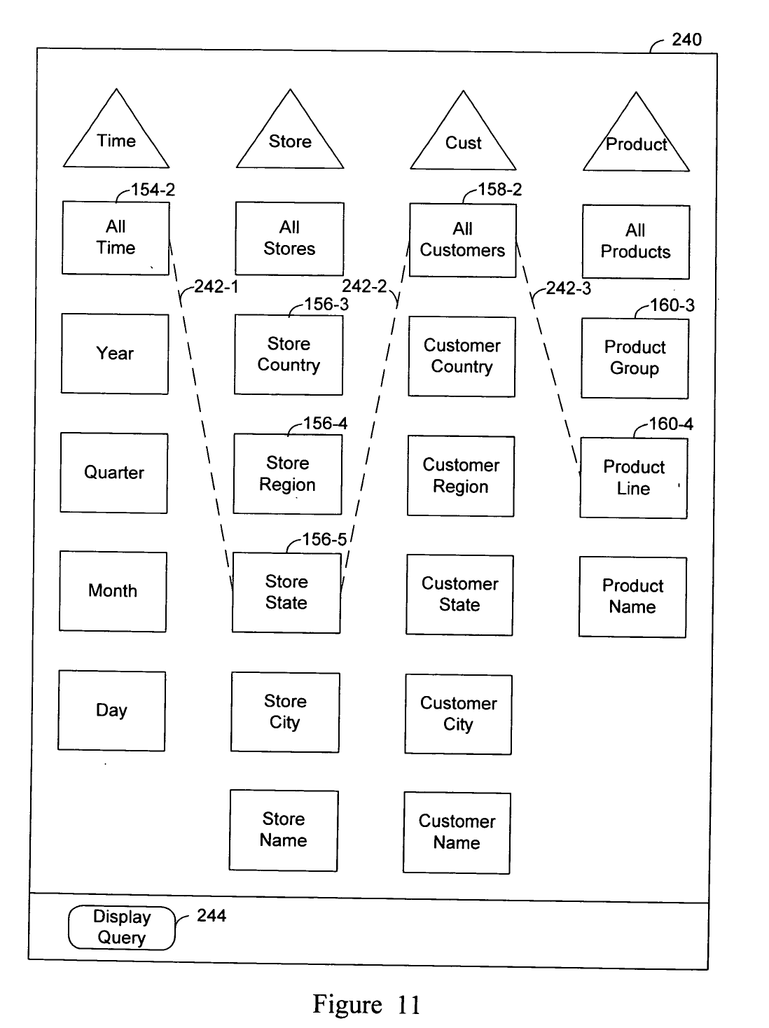

FIG. 11 depicts another embodiment of a graphical user interface which graphically displays a query which references data in the multidimensional model of FIG. 4. Although various embodiments will be described with respect to the structured query language (SQL), in other embodiments, other languages can be used. Consider the following exemplary SQL query:

Select

StoreCountry, StoreRegion, StoreState,
ProductGroup, ProductLine,
Sum(revenue) as revenue

from sales, store, product
where sales.storeid = store.storeid

And sales.productid = product.productid

group by

StoreCountry, StoreRegion, StoreState,

ProductGroup, ProductLine;

In the above SQL query, the StoreCountry, StoreRegion and StoreState levels are specified to uniquely identify the StoreState. In addition, the ProductGroup and ProductLine are specified to uniquely identify the ProductLine.

The above query is requesting data from the Store Country, Store Region, Store State, Product Group and Product Line levels, 156-3, 156-4, 156-5 and 160-3 and 160-4, respectively, for the all time and all customers levels, 154-2 and 158-2, respectively. In this example, the dashed line 242 connecting level indicators 154-2, 156-5, 158-2 and 160-4, represents the slice and the levels requested by the query. The dashed line 242 has 3 segments 242-1, 242-2 and 242-3.

A select query can also refer to a region that has multiple levels in a dimension. In some embodiments, a grouping set is used to specify multiple groups. For example, a query may group on country and state, and state and city in the store dimension of FIG. 6. In other embodiments, a query may group on a rollup of a specified level of a dimension in order to group on the specified level and the levels above the specified level. When a query refers to a region, a region indicator is displayed.

When activated, a display query button (Display Query) 244 invokes the display query handler 84 (FIG. 1) to display one or more slices and/or regions requested by one or more queries. In some embodiments, queries are displayed as they are received.

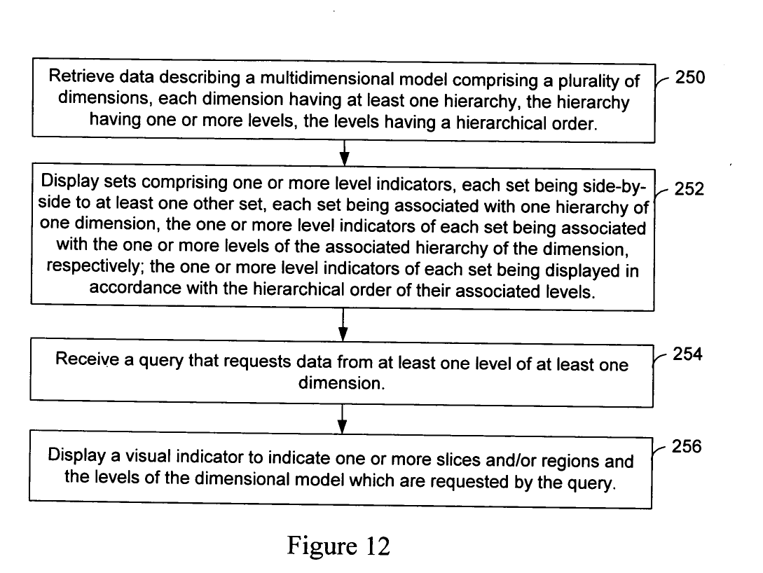

FIG. 12 depicts a flowchart of an embodiment of graphically displaying a query using the graphical representation of the multidimensional model shown in FIG. 11. Steps 250 and 252 of the flowchart of FIG. 12 are the same as steps 166 and 168 of FIG. 5B and will not be further described.

In step 254, a query that requests data from at least one level of at least one dimension is received. In step 256, a visual indicator is displayed to indicate one or more slices and/or regions and the level(s) of the dimensional model which are requested by the query. In various embodiments, for a slice, the visual indicator comprises one or more lines serially connecting the level indicators associated with the levels referenced by the query. In some embodiments, the lines are solid; in other embodiments, the lines are dashed; in yet other embodiments, the lines have a distinct color; and in yet other alternate embodiments the width of the lines is distinct.

In some embodiments, when a query references multiple levels in a hierarchy, a region has been referenced and a region indicator is displayed. In some embodiments, the region indicator comprises a line encompassing the level indicators associated with the referenced levels. In some embodiments, the line is solid; in other embodiments, the line is dashed; in yet other embodiments, the line has a distinct color; and in yet other alternate embodiments the width of the line is distinct. Alternately, distinctive color, shading, or other visual indicia is applied to the area of the dimensional model encompassing the level indicators of the region. In other embodiments, one or more slices and/or one or more regions are displayed. In some embodiments, the region indicator is also used to indicate a slice.

In various embodiments, the flowchart of FIG. 12 is implemented in the display query handler 84 (FIG. 1). In other embodiments, steps 254 and 256 are implemented in the display query handler 84 (FIG. 1).

Explaining a query means illustrating how the query will be processed. A query typically references base data, pre-aggregated data or data that is dynamically aggregated. When the query references base data, the base data is read. When the query references pre-aggregated data, the pre-aggregated data is read. If the requested data does not physically exist, either in base data or pre-aggregated data, then the data is dynamically aggregated if possible. Typically, when queries are executed, the database management system dynamically aggregates data.

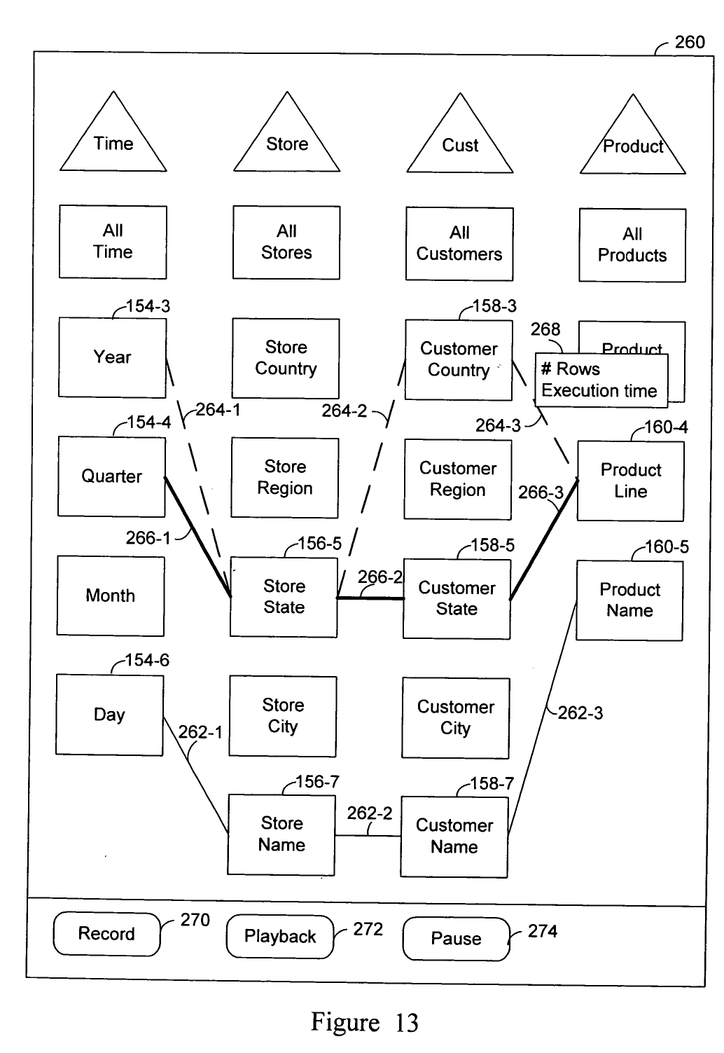

FIG. 13 depicts another embodiment of a graphical user interface comprising a graphical representation of a multidimensional model 260 which comprises a graphical representation of a query and which levels of physical data, either pre-computed aggregated data or the base data, will be accessed when processing the query. A first set of solid lines 262-1, 262-2 and 262-3 interconnects the level indicators associated with the levels that represent the base data to provide a base slice 262. The levels that represent the base data comprise the day, store name, customer name and product name levels, which are associated with level indicators 154-6, 156-7, 158-7 and 160-5, respectively. The levels requested by the query form another slice 264 and dashed lines 264-1, 264-2 and 264-3 interconnect the level indicators associated with that slice 264. The levels requested by the query comprise the year, store state, customer country and product line levels, which are associated with level indicators 154-3, 156-5, 158-3 and 160-4, respectively. A second set of solid lines 266-1, 266-2 and 266-3 interconnects the level indicators that represent the levels associated with a slice of pre-computed aggregated data. The level indicators that represent the levels associated with the slice of pre-computed aggregated data comprise the quarter, store state, customer state and product line levels, which are associated with level indicators 154-4, 156-5, 158-5 and 160-4, respectively. Since this query requests levels of data at or above the levels of the pre-computed aggregated data and that data is distributive, the levels having the pre-computed aggregated data will be accessed, and the requested aggregations are dynamically aggregated from the pre-computed aggregated data. In various embodiments, the line segments 266 of the slice associated with the levels of the pre-computed aggregated data that will be accessed are visually distinct from the line segments 264 which represent the slice associated with the requested levels. For example, the line segments 266 and 264 may have different colors, shading, width, visual effects such as blinking, and as in FIG. 13, one may be dashed and the other solid. In some embodiments, the line segments of the slice that is associated with the pre-computed, aggregated data are visually distinct from the line segments associated with the slice that is associated with the requested levels. In various embodiments, the level indicators that are associated with the pre-computed, aggregated data that will be accessed are also visually distinct from the level indicators associated with the requested levels, except when a level indicator is associated with a level that is both requested and accessed. In some embodiments, when a level indicator is associated with a level that is both requested and accessed, that level indicator has both the distinguishing indicia associated with a request and access.

In some embodiments, additional information 268 is provided to the user. The additional information 268 comprises the execution time of the query and/or the number of rows that will be returned.

In various embodiments, the graphical user interface further comprises record, playback and pause buttons, 270, 272 and 274, respectively. The operation of the record, playback and pause buttons, 270, 272 and 274, respectively, will be described in further detail below.

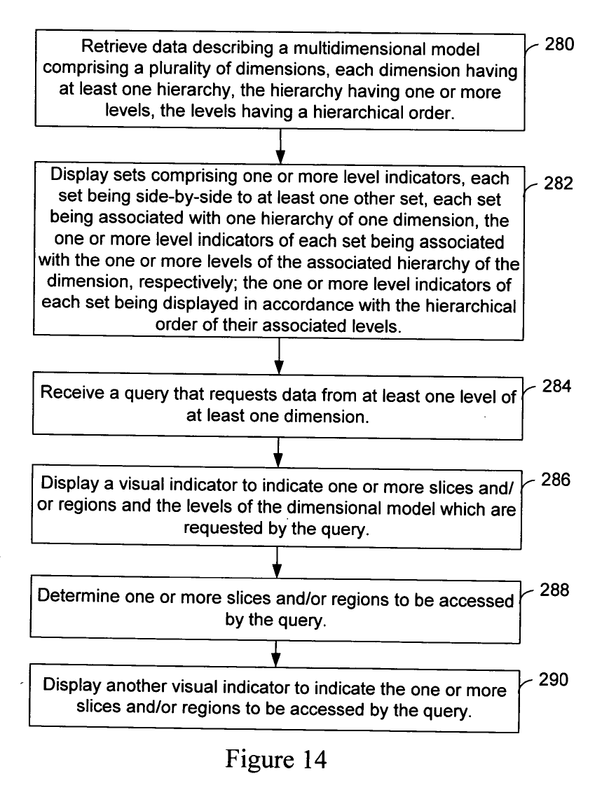

FIG. 14 depicts a flowchart of an embodiment of graphically displaying how a query would be processed using the graphical representation of the multidimensional model of FIG. 13. In some embodiments, the flowchart of FIG. 14 is implemented in the display query handler 84 of FIG. 1. Steps 280-286 of the flowchart of FIG. 14 are the same as steps 250-256 of FIG. 12 and will not be further described.

In step 288, one or more slices and/or regions to be accessed by the query are determined. In step 290, a visual indicator is displayed to indicate one or more slices and/or regions of the dimensional model to be accessed by the query. In various embodiments, for a slice, the visual indicator is a series of lines that interconnect the level indicators associated with the levels storing the data to be accessed by the query. For a region, a region indicator is displayed.

U.S. patent application, Ser. No. 10/325,245, filed on Dec. 18, 2002, entitled “System and Method for Automatically Building an OLAP Model in a Relational Database,” to Nathan Gevaerd Colossi and Daniel Martin DeKimpe, describes embodiments of a technique for mapping a SQL query to OLAP meta-data.

In various embodiments, query execution information such as the number of rows read and execution time is displayed. In some embodiments, one or more slices and/or regions that are accessed frequently are indicated graphically. For example, the frequency of access for a region or slice is determined. When the frequency of access exceeds a predetermined threshold, visual indicia is applied to the graphical model. In some embodiments, a line is drawn around the level indicators associated each slice and/or region that is accessed frequently. In other embodiments, shading, a predetermined color, or other distinct visual indicia, is applied to regions which are accessed frequently.

Alternately, a predetermined number of the most frequently accessed slices and/or regions are identified, and distinct visual indicia is applied to the graphical model to indicate the most frequently accessed slices and/or regions. In other embodiments, another visual indicator, for example, shading, a predetermined color or other distinct visual indicia, is applied to regions and/or slices in which queries execute slowly.

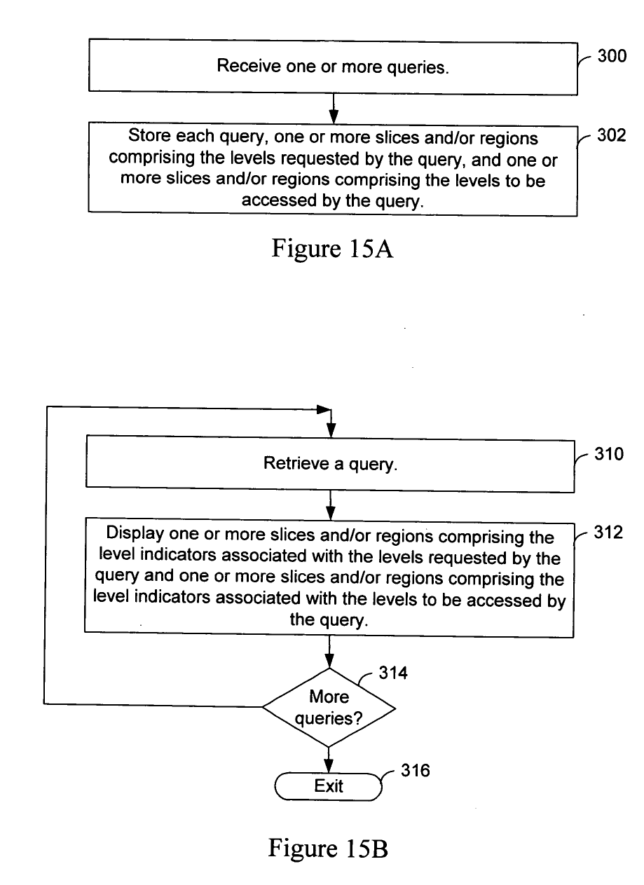

FIGS. 15A and 15B depict flowcharts of embodiments of the record and playback operations provided by the record and playback buttons, 270 and 272 (FIG. 13), respectively. In some embodiments, when activated, the record button 270 (FIG. 13) causes a series of queries, their one or more requested slices and/or regions and the associated levels to be accessed are stored. When deactivated, queries are no longer stored. FIG. 15A depicts a flowchart of an embodiment of the record operation. In various embodiments, the flowchart of FIG. 15A is implemented in the record handler 86 of FIG. 1. When the record button 270 (FIG. 13) is activated, the record handler 86 (FIG. 1) is invoked. In step 300, a query is received. In step 302, the query, one or more slices and/or regions and the associated levels requested by the query, and one or more slices and/or regions and the associated levels accessed during query execution are stored. In some embodiments, other information about the query is also stored. The other information comprises the number of rows referenced by the query and/or the execution time for the query.

FIG. 15B depicts a flowchart of an embodiment of an animated playback of the set of queries that were recorded using the flowchart of FIG. 15A. The animated playback graphically illustrates how queries were processed. When activated, the play-back button 272 (FIG. 13) causes each query in the series of queries to be graphically displayed with the levels requested and accessed by the query as shown in FIG. 13. In various embodiments, the flowchart of FIG. 15B is implemented in the playback handler 88 (FIG. 1). When the playback button 272 (FIG. 13) is activated, the playback handler 88 (FIG. 1) is invoked.

In step 310, a query is retrieved. In step 312, one or more slices and/or regions comprising the level indicators for the associated levels requested by the query are displayed, and one or more slices and/or regions comprising the level indicators for the associated levels accessed by the query are displayed. A slice is displayed using any of the embodiments described above, and a region is displayed using region indicator. The one or more slices and/or regions requested by the query are visually distinguishable from the one or more slices and/or regions accessed by the query. In some embodiments, information about the query that was stored in step 302 of FIG. 15A is displayed. The slices, regions and other information associated with the query are displayed for a predetermined time before displaying the information for the next query. Step 314 determines if there are more queries to playback. If so, step 314 proceeds to step 310 to display the next query. If not, in step 316, the playback ends. In various embodiments, when activated, the pause button 274 (FIG. 13) invokes the pause handler 90 (FIG. 1) which pauses the animated playback. In other embodiments, when step 314 determines that there are no more queries to playback, step 314 proceeds to step 310 to retrieve the first query that was recorded and continues in a loop until the playback button 272 (FIG. 13) is deactivated.

In various embodiments, in step 302 of FIG. 15A, subsets of queries are stored based on filtering criteria. The filtering criteria comprise the amount of time to execute the query, the number of rows returned by the query, and the amount of resources used by the query. In some embodiments, one or more slices and/or regions comprising the levels of data requested and accessed, and other information about a query is stored when the amount of time to execute the query exceeds a predetermined execution-time threshold. In other embodiments, one or more slices and/or regions comprising the levels of data requested and accessed, and other information about a query is stored when the number of rows returned by the query exceeds a size threshold. In yet other embodiments, one or more slices and/or regions comprising the levels of data requested and accessed, and other information about a query is stored when the amount of resources used, such as processor time, exceeds a processor-time predetermined threshold.

In some embodiments, in step 312 of FIG. 15B a subset of queries is displayed. In step 312 of FIG. 15B, one or more slices and/or regions comprising the level indicators associated with the levels of data requested and accessed, and other information about a query is displayed when the query meets specified filtering criteria. In some embodiments, one or more slices and/or regions comprising the level indicators associated with the levels of data requested and accessed, and other information about a query are displayed when the amount of time to execute the query exceeds a predetermined execution-time threshold. In other embodiments, one or more slices and/or regions comprising the level indicators associated with the levels of data requested and accessed, and other information about a query are displayed when number of rows returned by the query exceeds a size threshold. In yet other embodiments, one or more slices and/or regions comprising the level indicators associated with the levels of data requested and accessed, and other information about a query are displayed when the amount of resources used, such as processor time, exceeds predetermined a processor-time threshold.

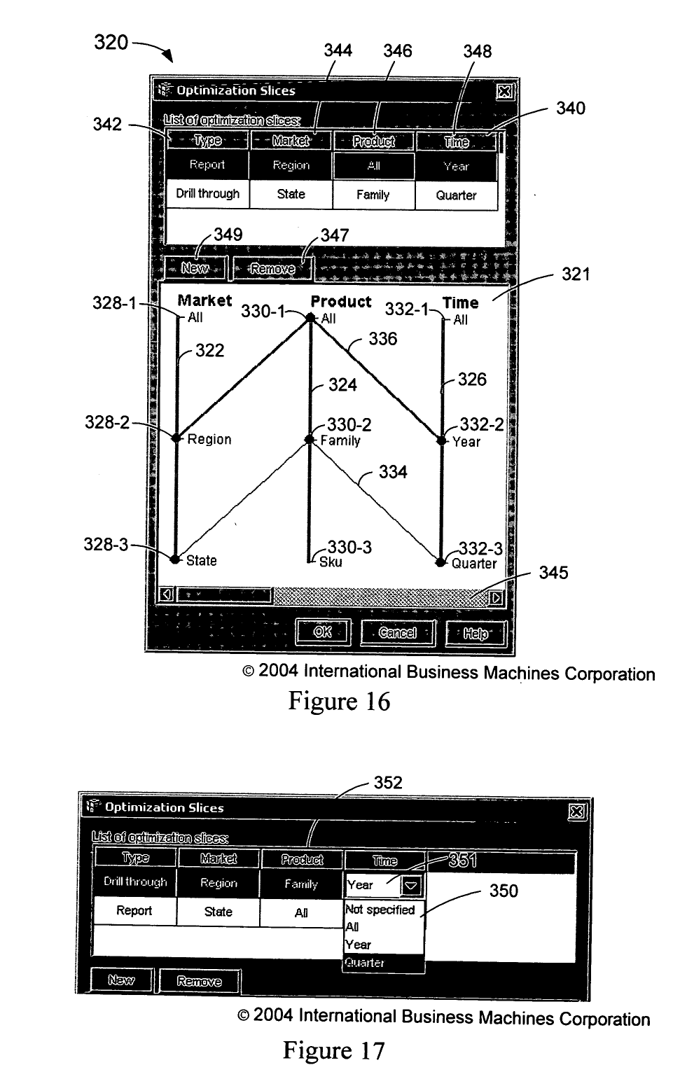

FIG. 16 depicts another embodiment of a graphical user interface 320 comprising a graphical representation of a multidimensional model 321 provided by another embodiment of the application of FIG. 1. In this embodiment, a user specifies one or more optimization slices using the graphical user interface 320. An optimization slice may be slice or a region and is used to describe query activity to influence a performance advisor in recommending summary tables. In some embodiments, the performance advisor is part of the application 62 (FIG. 1); in other embodiments, the performance advisor is separate from the application 62 of FIG. 1. U.S. patent application, Ser. No. 10/410,793, filed Apr. 9, 2003, entitled “Method, System, and Program for Improving Performance of Database Queries,” to Nathan Gevaerd Colossi et al. describes various embodiments of a performance advisor. U.S. patent application, Ser. No. ______. filed on the same date herewith, entitled “Model Based Optimization with Focus Regions,” to Nathan Gevaerd Colossi et al. IBM Docket No. SVL920040016US1, describes various embodiments of focus regions which, in some embodiments, is an optimization slice.

The dimensions, and in some embodiments, a hierarchy within the dimension, are presented as vertical lines 322, 324 and 326 with level indicators, also referred to as nodes, 328-1, 328-2, 328-3, 330-1, 330-2, 330-3, 332-1, 332-2 and 332 for each level. In this embodiment, the level indicator for a node comprises a line and the name of the associated level, for example level indicator 328-1 for the “All” level when no region or optimization slice is associated with the node. When a region or optimization slice 336 is associated with a node, an additional graphical element, a circle, is superimposed, for example, node 328-2. In some embodiments, the additional graphical element is part of the level indicator for that node. The optimization slices are associated with a query type. A first optimization slice 334 is associated with a query type of “Drill through.” A second optimization slice 336 is associated with a query type of “Report.” The line segments interconnecting the level indicators of the first and second optimization slices are visually distinguishable. In some embodiments, the line segments of the first and second optimization slices, 334 and 336, respectively, have different colors. A table view 340 of the slices 334 and 336 allows users to see and update properties of the optimization slices such as the query type (Type) 342 and dimension, or alternately, hierarchy, levels, for example, market (Market), product (Product) and time (Time), 344, 346 and 348, respectively. For example, for an optimization slice 336 having a query type of report, the table view 340 displays the levels of Region, All and Year. The query type and levels may be changed by clicking on the cells (list boxes) in the table and using the resultant pull down menu 350 (FIG. 17). An optimization slice may also be selected by clicking on a line segment associated with the slice. When a remove button (Remove) 347 is activated, the selected optimization slice is removed from the display. When a new button (New) 349 is activated, an optimization slice may be selected by clicking on the level indicators or using the table view 340. A horizontal scrollbar 345 allows a user to scroll the graphical representation of the multi-dimensional model.

In other embodiments, the lines representing the dimensions may be horizontal rather than vertical. In some embodiments, the flowchart of FIG. 5A is modified to display the graphical representation of the multidimensional model of FIG. 16. Step 165 is modified to display the graphical representation of the multidimensional model of FIG. 16. Step 165 also displays a line for each group. Level indicators are disposed on the line for the levels of the group in a hierarchical order. In some embodiments, the level indicators for a group are disposed on the line at equal or uniform intervals. In other embodiments, the level indicators may be disposed on the line at non-uniform intervals.

In other embodiments, the flowchart of FIG. 5B is modified to display the graphical representation of the multidimensional model of FIG. 16. Step 168 also displays a line for each dimension. Level indicators are disposed on the line for the levels of the dimension in a hierarchical order. In some embodiments, the level indicators for a dimension are disposed on the line at equal or uniform intervals. In other embodiments, the level indicators may be disposed on the line at non-uniform intervals.

In other embodiments, the graphical representation of the multidimensional model of FIG. 16 is used to represent slices and regions, and can used with any of the other embodiments described above that use the graphical representation of the multidimensional model of FIGS. 4, 6, 11 and 13. For example, in various embodiments, the graphical representation of the multidimensional model of FIG. 16 may be used to display a multidimensional model, to display slices and regions in the multidimensional model, to select slices and regions in the multidimensional model to generate aggregations, export data, or generate queries, to display additional information and metrics about a slice or region, and be used with record and playback.

FIG. 17 depicts an embodiment of an exemplary table view 352 with a pull down menu 350 of a list box 351 suitable for use in another embodiment of the graphical user interface of FIG. 16. The pull down menu 350 allows a user to select a level, and in some embodiments, no level.

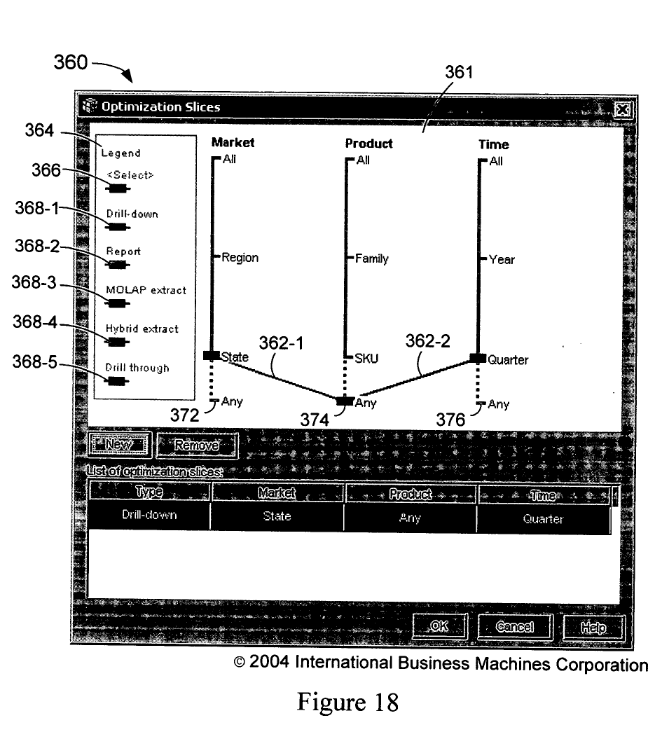

FIG. 18 depicts another embodiment of a graphical user interface 360 comprising a graphical representation of the dimensional model 361 with a single optimization slice 362 displayed by an embodiment of the application 60 of FIG. 1. In this embodiment, when an optimization slice 362 is associated with a node, an additional graphical element, a rectangular box is superimposed on the node, for example, node 374. A legend 364 has a select icon 366 that allows a user to select an optimization slice. When an optimization slice is selected, for example by clicking on a line 362-1 or 362-2 with a mouse, the lines associated with the optimization slice are displayed in a color. When an optimization slice is not selected, the lines associated with the optimization slice are grayed. In other embodiments, the lines of different optimization slices have different colors.

Optimization slices may be associated with various types of queries. The query types comprise drill-down, report, MOLAP extract, Hybrid extract and drill through, 368-1, 368-2, 368-3, 368-4 and 368-5, respectively. Drill down refers to a set of queries that are navigating through the aggregated data starting at a high level and drilling down to more detailed data. An optimization slice for a drill-down query describes a subset of the model within which the drill down queries are likely to occur. Typically an explicit level is specified for one or two dimensions and the other dimensions are specified as “Any”. When an explicit level is specified, the performance advisor will include that level in the optimization. “Any” means that the performance advisor determines where to optimize within this dimension.

A report query type refers to queries that tend to hit anywhere within the model. An optimization slice for a report query describes a subset of the model within which the report queries are likely to occur. Typically an explicit level is specified for one or two dimensions and the other dimensions are specified as “Any.”

Multi-dimensional OLAP (MOLAP) refers to OLAP systems in which special-purpose file systems or indexes are used to store data. An optimization slice for a MOLAP extract query type specifies which level of the aggregated data is read (extracted) from the model into the MOLAP data store. Typically an explicit level will be specified for each dimension because the user knows exactly what data is being read.

A hybrid OLAP (HOLAP) system typically stores the data for higher levels in one data store, such as a MOLAP data store, and the lower level data is another data store. An optimization slice for a hybrid extract or HOLAP query specifies which level of the aggregated data is read (extracted) from the multidimensional model into the MOLAP data store. Typically an explicit level will be specified for each dimension because exactly what data is read is known. One distinction between a HOLAP system and a MOLAP system is that in a HOLAP system there may be queries that leave the MOLAP data store and reference back into the data store of the multidimensional model.

Drill though refers to queries generated by the HOLAP system when a user navigates from higher level to lower level data in different data stores. An optimization slice for a drill through query type specifies portions of the model that are outside of the MOLAP data store defined by the hybrid extract line but likely to be accessed by users.

In FIG. 18, the term “Any” 372, 374 and 376 is displayed as an extension of the dimensional hierarchies as a pseudo-level. The “Any” level specifies a dimension in which the performance advisor selects the level. In some embodiments, a user may request that the performance advisor suggest summary tables, and the optimization slice is supplied as part of that request. Alternately, the optimization slice is specified and stored in the meta-data prior to a sending a request that the performance advisor suggest summary tables. The “Any” level is included in the optimization slice. “Any” can be considered as a shorthand representation for a range of all levels in a dimension, and when the performance advisor receives the “Any” level, the performance advisor selects the level for that dimension when suggesting summary tables.

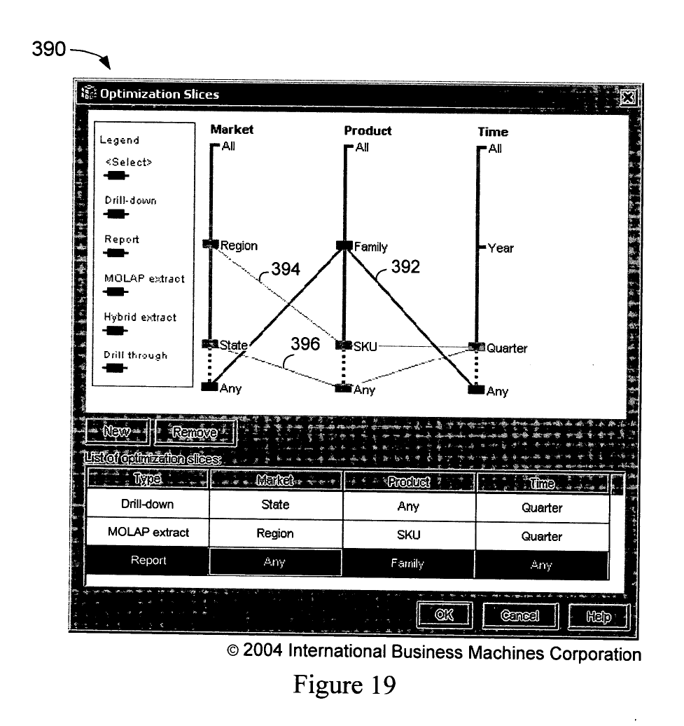

FIG. 19 depicts an embodiment of a graphical user interface 390 comprising a graphical representation of a multidimensional model with multiple optimization slices 392, 394 and 396 displayed by an embodiment of the application 60 of FIG. 1.

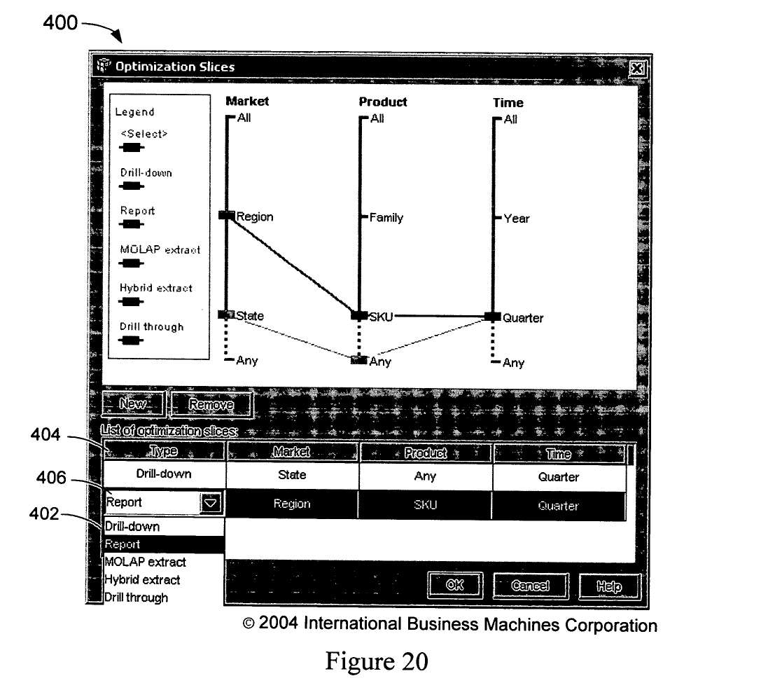

FIG. 20 depicts another embodiment of graphical user interface comprising a graphical representation of a multidimensional model 400 with a pull down menu 402 to select the query type in an embodiment of the application 60 of FIG. 1. In the table view 404, each cell or list box 406 is associated with a pull down menu which appears when the cell is clicked on.

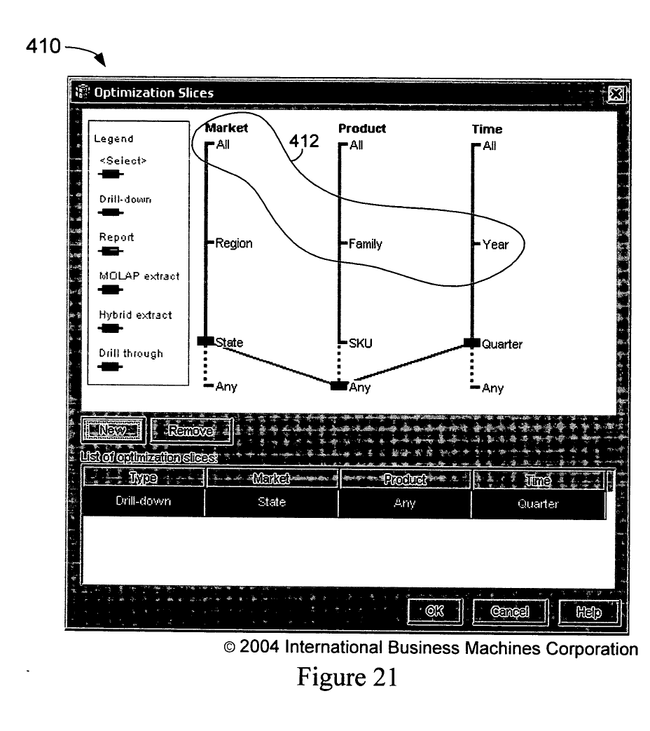

FIG. 21 depicts another embodiment of graphical user interface comprising a graphical representation of a multidimensional model 410 in which a user has selected an optimization slice by using a mouse to enclose the level indicators of the slice within a boundary 412, or region indicator, in an embodiment of the application 60 of FIG. 1. In other embodiments, when a plurality of levels of a hierarchy are enclosed a region has been selected.

In other embodiments, the graphical representation of the multidimensional model of FIGS. 18, 19, 20 and 21 is used to represent slices and regions, rather than optimization slices, and is used with any of the other embodiments described above that use the graphical representation of the multidimensional model of FIGS. 4, 6, 11 and 13.

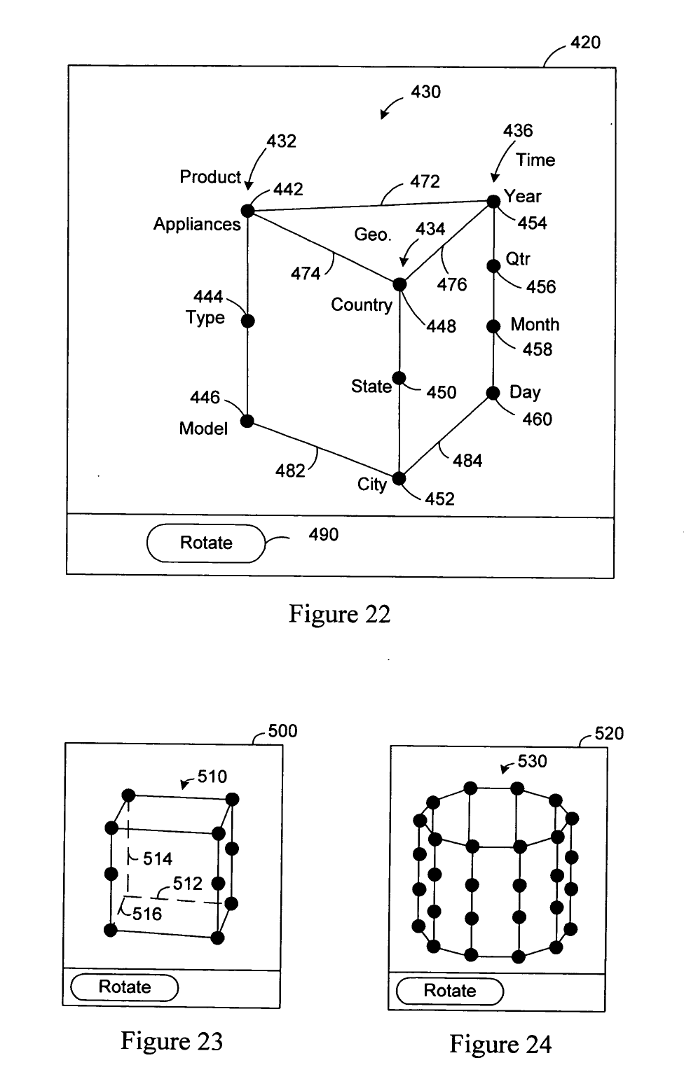

FIG. 22 depicts an embodiment of a graphical user interface 420 comprising a three-dimensional graphic representation 430 of three dimensions of a multidimensional model. The dimensions of the multidimensional model are displayed using a polyhedron. In some embodiments, the polyhedron is a prism. A prism is a figure having two congruent polygons with their corresponding sides parallel (the bases). The lateral faces of the prism are formed by joining the corresponding vertices of the polygons. The lines joining the vertices of the polygons are lateral edges. Each dimension in the subset is represented as a dimension line 432, 434 and 436. The dimension lines 432, 434 and 436 are used for the lateral edges of the prism. In some embodiments, the dimension lines 432, 434 and 436 are vertical. In various embodiments, the prism may be concave or convex, regular or oblique. In some embodiments, the dimension lines 432, 434 and 436 are not in any predetermined order. In other embodiments, the dimension lines 432, 434 and 436 are in a predetermined order. The dimension lines 432, 434 and 436 are considered to be side-by-side. Each dimension line is side-by-side to two other dimension lines.

The levels of the dimensions are represented by level indicators 442, 444 and 446; 448, 450 and 452; and 454, 456, 458, and 460 on dimension lines 432, 434 and 436, respectively. In FIG. 21, the level indicators are represented by dots. In other embodiments, the level indicators may be other than dots, for example as shown in FIGS. 4 and 21 above. In various embodiments, the level indicators can be repositioned using the mouse and cursor.

In some embodiments, the distance between adjacent dimension lines is illustrated such that the distance appears to be the same. In other embodiments, the distance between adjacent dimension lines can vary.

Connecting lines 472, 474, 476, 482 and 484 illustrate the bases of the prism. In FIG. 22, hidden lines, for example a connecting line between the Model and Day level indicators, 446 and 460, respectively, are not shown.

A rotate button (Rotate) 590, when activated, causes the three-dimensional representation 430 to rotate. In various embodiments, the three-dimensional representation 430 is rotated about a central vertical axis. In some embodiments, when the rotate button is activated, a user can grab the three-dimensional representation 430 using the cursor and mouse, and rotate the three-dimensional representation 430 around a horizontal (x), vertical (y), or depth (z) axis, or a combination thereof. In other embodiments, the user can grab the three-dimensional representation 430 using the cursor and mouse, and rotate the three-dimensional representation 430 at any time, without using a rotate button.

FIG. 23 depicts an embodiment of a graphical user interface 500 comprising a three-dimensional graphical representation 510 of four dimensions of a multidimensional model. For simplicity, the names of the dimensions and levels are not shown. In FIG. 23, hidden lines 512, 514 and 516 are shown as dashed lines.

FIG. 24 depicts an embodiment of a graphical user interface 520 comprising a three-dimensional graphical representation 530 of ten dimensions of a multidimensional model. In FIG. 24, hidden lines are not shown.

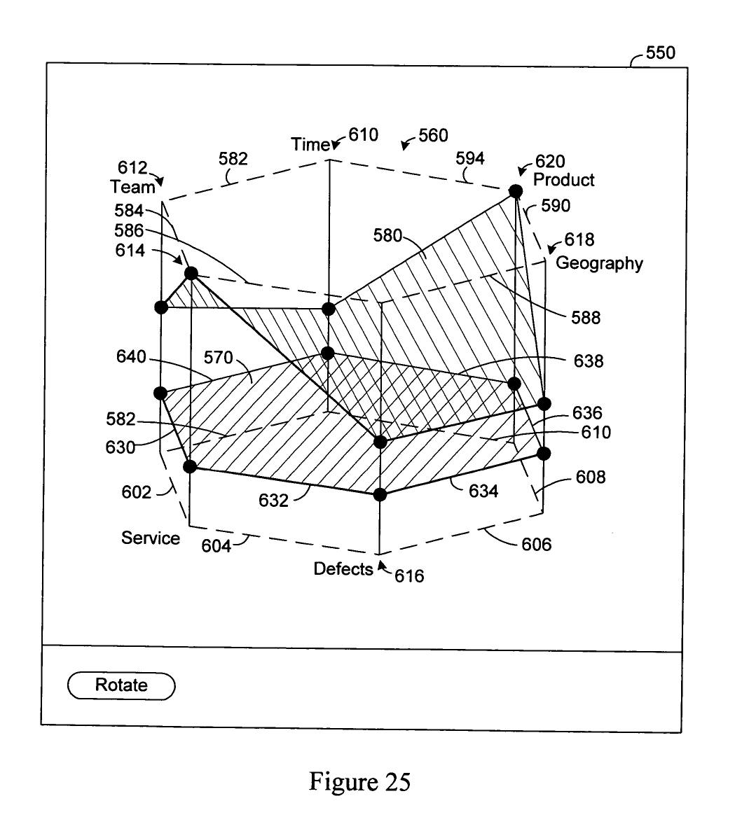

FIG. 25 depicts an embodiment of a graphical user interface 550 comprising a three-dimensional graphic representational 560 of six dimensions of a multidimensional model and two slices—a first slice 570 and a second slice 580. In FIG. 25, dashed lines 582, 584, 586, 588, 590 and 592 connect adjacent dimension lines 610, 612, 614, 616, 618 and 620 at the top and bottom to illustrate the three-dimensional relationship of the dimensions. The first slice 570, having a first pattern, represents aggregations associated with a first set of levels in the dimensions. Solid lines 630-640 connect the level indicators associated with the first set of levels of the slice. In some embodiments, the solid lines at the front of the polygon 630-634 are wider than the solid lines at the back of the slice 636-640. The second slice 580, having a second pattern, represents aggregations associated with a second set of levels in the dimensions. In FIG. 25, each slice 570 and 580 is transparent and where the slices visually overlap, that area is crosshatched. In other embodiments, the visually closer slice obscures other slices. In yet other embodiments, slices have different colors rather than black and white patterns. In some other embodiments, various textures are applied to the slices. Typically, each displayed slice is visually distinct.

In various embodiments, when the cursor is positioned over a particular slice, that slice is highlighted. In some embodiments, when the cursor is positioned over a particular slice, the measure information will be displayed. In other embodiments, when the cursor is positioned over a particular slice, the number of aggregations in that slice is displayed.

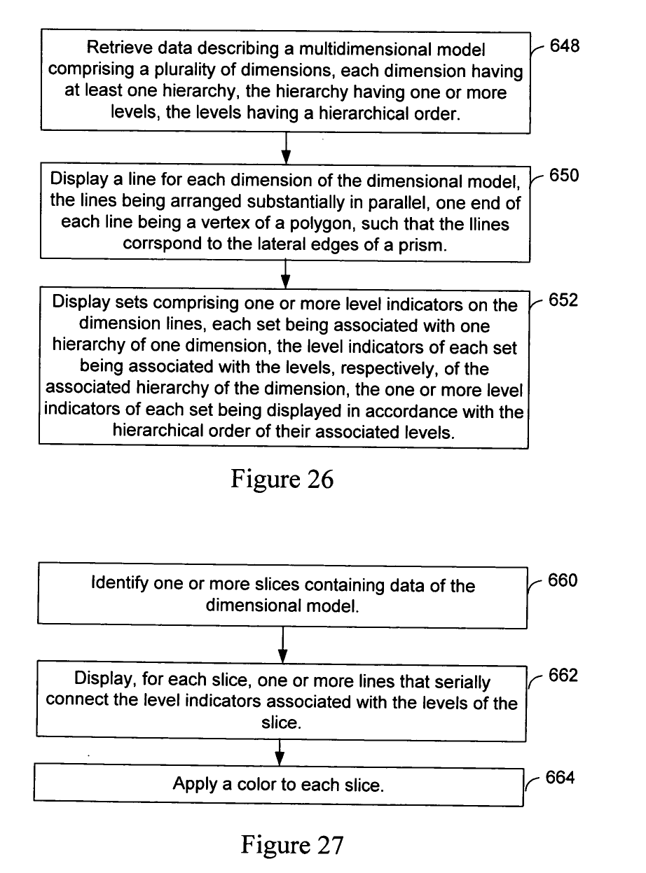

FIG. 26 depicts a flowchart of an embodiment of displaying the dimensions of a multidimensional model in three-dimensions. In some embodiments, the flowchart of FIG. 26 is implemented in the display model handler 76 of FIG. 1. Step 648 is the same as step 166 of FIG. 5B and will not be further described. In step 650, dimension lines for the dimensions of the dimensional model are displayed. The dimension lines are arranged substantially in parallel, one end of each dimension line being a vertex of a polygon such that the lines correspond to the lateral edges of a prism. In some embodiments, base lines that connect the vertices of each polygon are displayed to illustrate the polygons. Typically, the base lines are visually distinct from the dimension lines. In some embodiments, the base lines are dashed lines, as shown in FIG. 25; in other embodiments, the base lines are a different color from the dimension lines. In some alternate embodiments, the base lines are omitted.

In step 652, sets comprising one or more level indicators are displayed on the dimension lines. Each set is associated with one hierarchy of one dimension. The level indicators of each set are associated with the levels, respectively, of the associated hierarchy of the dimension. The one or more level indicators of each set are displayed in accordance with the hierarchical order of their associated levels.

FIG. 27 depicts a flowchart of displaying slices on a three dimensional multidimensional model. In some embodiments, the flowchart of FIG. 27 is implemented in the display data handler 78 of FIG. 1. In step 660, one or more slices containing data of the dimensional model are identified. In step 662, for each slice, one or more lines that serially connect the level indicators associated with the levels of the slice are displayed. In various embodiments, the level indicators of a dimension are displayed along a lateral edge of a prism, and the lines that serially connect the level indicators associated with the levels of the slice are displayed along the lateral faces of the prism. In step 664, a color is applied to each slice; in some embodiments, color is also applied to the area within the lines forming the edges of the slice. In some embodiments, step 664 is omitted. In other embodiments, each slice is transparent so that when slices overlap, the colors are blended. In other embodiments, each slice is opaque, and the foremost slice is displayed.

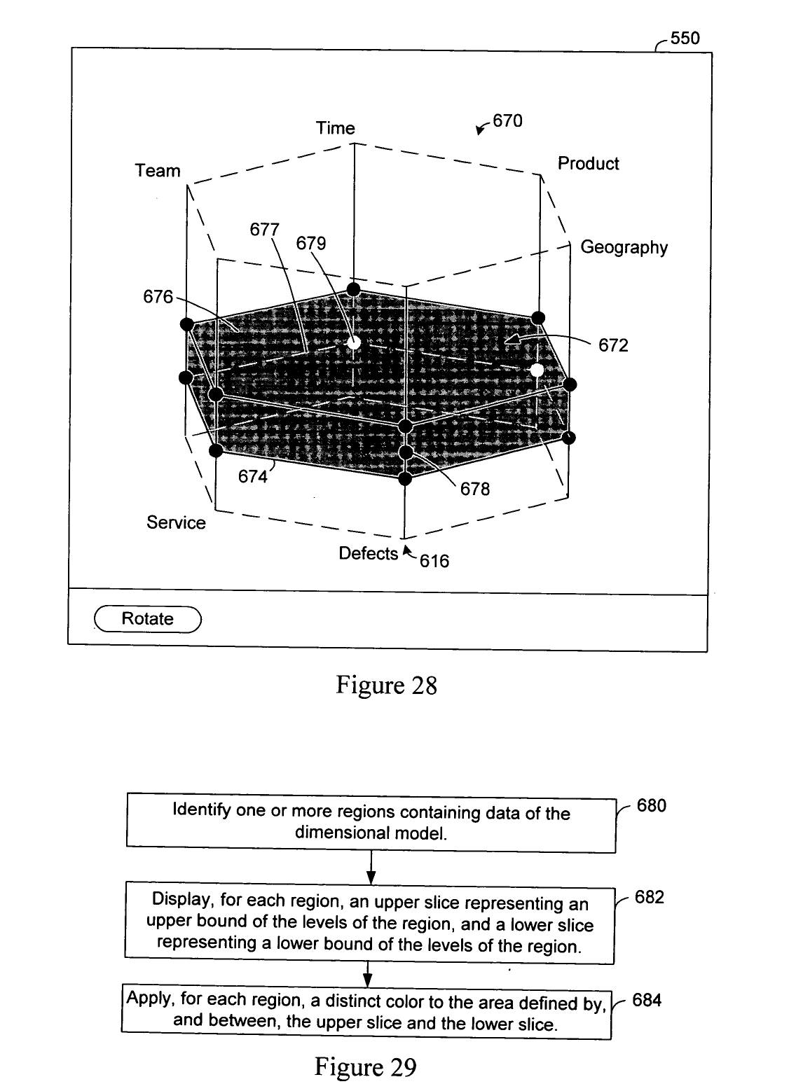

FIG. 28 depicts an embodiment of a graphical user interface comprising a three-dimensional graphical representation of a multidimensional model having six dimensions 670 and an exemplary region 672. The region 672 (shaded) is bounded by a lower slice 674 and an upper slice 676. In the defects dimension 616, the region 672 encompasses a level 678 between the levels associated with the upper and lower slices 674 and 676, respectively. In some embodiments, hidden lines 677 are shown as dashes using another color, for example, white; and hidden nodes 679 are shown in another color, for example, white.

In other embodiments, a region may comprise non-contiguous levels. For example, if node 678 were excluded, node 678 may have distinct visual indicia, such as color, shading or shape. In various embodiments, the region indicator would not touch node 678.

FIG. 29 depicts a flowchart of displaying a region on a three dimensional multidimensional model. In some embodiments, the flowchart of FIG. 29 is implemented in the display data handler 78 of FIG. 1. In step 680, one or more regions containing data of the dimensional model are identified. In step 682, an upper slice representing an upper bound of the levels of the region and a lower slice representing a lower bound of the level of the region are displayed for each region. In step 684, for each region, a distinct color is applied to the area defined by and between the upper slice and the lower slice.

The three-dimensional graphical representation of the multidimensional model, slices and regions may be used in any of the embodiments for the two-dimensional graphical representation of the multi-dimensional model described above.

The three-dimensional representation of the multidimensional model has been described with respect to dimensions. In another embodiment, for example, when an OLAP system does not use dimensions, hierarchies are used rather than dimensions, and the hierarchies are displayed using the dimension lines. In yet another embodiment, when an OLAP system has dimensions with multiple hierarchies, the levels of a single hierarchy are displayed for a dimension. In yet another embodiment, when an OLAP system has dimensions with multiple hierarchies, a subset or, alternately, all of the hierarchies are displayed such that each displayed hierarchy is represented on a separate dimension line.

Various embodiments of the present invention can be applied to many OLAP applications—MOLAP, Relational OLAP (ROLAP), HOLAP and Data warehousing and OLAP (DOLAP) systems. In addition, some embodiments of the present invention may be used with any query language that is multidimensional in nature such as MDX, SQL and JOLAP.

The foregoing detailed description of various embodiments of the invention has been presented for the purposes of illustration and description. It is not intended to be exhaustive or to limit the invention to the precise form disclosed. Many modifications and variations are possible in light of the above teachings. It is intended that the scope of the invention be limited not by this detailed description, but rather by the claims appended thereto.

1. A computer-based method of visualizing a multidimensional model comprising:
retrieving data describing a multidimensional model comprising a plurality of groups, each group having one or more levels, the levels having a hierarchical order;
displaying a plurality of sets comprising one or more level indicators, each set being side-by-side to at least one other set, each set being associated with one group of the plurality of groups, the one or more level indicators of each set being associated with the one or more levels of the associated group, respectively, the one or more level indicators of each set being displayed in accordance with the hierarchical order of their associated levels; and
displaying a visual indicator associated with a subset comprising one or more level indicators of each set.

2. The method of claim 1 further comprising:
displaying a line connecting the level indicators of each set, the line of each set being separate.

3. The method of claim 1 further comprising:
displaying visual indicia to indicate the sets.

4. The method of claim 1 wherein the visual indicator is a region indicator.

5. The method of claim 1 wherein the subset comprises one level indicator of each set, and the visual indicator comprises one or more lines connecting the level indicators of the subset.

6. The method of claim 1 wherein the level indicators of the subset are associated with levels which are associated with an aggregation of the multidimensional model.

7. The method of claim 1 further comprising:
displaying, for each group, a list box comprising a name associated with one of the levels of that group.

8. The method of claim 1 further comprising:
prior to said displaying said visual indicator, selecting the level indicators of the subset; and
generating aggregations in accordance with the levels associated with the level indicators of the subset.

9. The method of claim 1 further comprising:
prior to said displaying said visual indicator, selecting the level indicators of the subset; and
exporting aggregations associated with the levels associated with the level indicators of the subset.

10. The method of claim 1 further comprising:
prior to said displaying said visual indicator, selecting the level indicators of the subset; and
generating a query in accordance with the levels associated with the level indicators of the subset.

11. The method of claim 1 further comprising:
receiving a query; and
determining one or more levels that are requested by the query, and the associated level indicators to provide the subset.

12. The method of claim 1 further comprising:
receiving a query; and
determining one or more levels that will be accessed by that query, and also determining the associated level indicators of the one or more levels that will be accessed by the query to provide the subset.

13. The method of claim 1 further comprising:
receiving a plurality of queries;
for each query, determining one or more levels that are accessed by that query;
in response activating a record operation, storing the queries and the levels that are accessed by the queries; and
wherein said displaying said visual indicator is performed in response to activating a playback operation, such that the queries and the levels accessed by the queries are sequentially retrieved, the level indicators associated with the levels that are accessed by the query are determined to provide the subset, and said displaying said visual indicator is performed for each query.

14. The method of claim 1 further comprising;
receiving a plurality of queries;
for each query, determining one or more regions comprising one or more levels accessed by that query and associated level indicators to provide the subset for each query;
determining an access frequency for the one or more regions; and
for each region, when the access frequency exceeds a predetermined threshold, displaying another visual indicator which indicates that the region is frequently accessed.

15. The method of claim 1 further comprising:
displaying an any-level associated with each set.

16. The method of claim 1 further comprising:
when said visual indicator is activated, determining levels associated with the level indicators of the subset, and displaying additional information regarding the levels associated with the subset.

17. The method of claim 2 wherein each line corresponds to a lateral edge of a prism to form a three-dimensional representation.

18. The method of claim 1 wherein each displayed set corresponds to a lateral edge of a prism, the subset comprises one level indicator from each set, wherein said displaying said visual indicator displays one or more lines that connect each level indicator of the subset along one or more lateral faces of the prism, respectively.

19. The method of claim 17 wherein the subset comprises a plurality of level indicators of at least one set.

20. The method of claim 17 further comprising:
rotating the three-dimensional representation.

21. An article of manufacture comprising a computer program usable medium embodying one or more instructions executable by a computer for performing a method of visualizing a multidimensional model, said method comprising:
retrieving data describing a multidimensional model comprising a plurality of groups, each group having one or more levels, the levels having a hierarchical order;
displaying a plurality of sets comprising one or more level indicators, each set being side-by-side to at least one other set, each set being associated with one group of the plurality of groups, the one or more level indicators of each set being associated with the one or more levels of the associated group, respectively, the one or more level indicators of each set being displayed in accordance with the hierarchical order of their associated levels; and
displaying a visual indicator associated with a subset comprising one or more level indicators of each set.

22. The article of manufacture of claim 21 wherein said method further comprises:
displaying a line connecting the level indicators of each set, the line of each set being separate.

23. The article of manufacture of claim 21 wherein said method further comprises:
displaying visual indicia to indicate the sets.

24. The article of manufacture of claim 21 wherein the visual indicator is a region indicator.

25. The article of manufacture of claim 21 wherein the subset comprises one level indicator of each set, and the visual indicator comprises one or more lines connecting the level indicators of the subset.

26. The article of manufacture of claim 21 wherein the level indicators of the subset are associated with levels which are associated with an aggregation of the multidimensional model.

27. The article of manufacture of claim 21 wherein said method further comprises:
displaying, for each group, a list box comprising a name associated with one of the levels of that group.

28. The article of manufacture of claim 21 wherein said method further comprises: prior to said displaying said visual indicator, selecting the level indicators of the subset; and
generating aggregations in accordance with the levels associated with the level indicators of the subset.

29. The article of manufacture of claim 21 wherein said method further comprises:
prior to said displaying said visual indicator, selecting the level indicators of the subset; and
exporting aggregations associated with the levels associated with the level indicators of the subset.

30. The article of manufacture of claim 21 wherein said method further comprises:
prior to said displaying said visual indicator, selecting the level indicators of the subset; and
generating a query in accordance with the levels associated with the level indicators of the subset.

31. The article of manufacture of claim 21 wherein said method further comprises:
receiving a query; and
determining one or more levels that are requested by the query, and their associated level indicators to provide the level indicators of the subset.

32. The article of manufacture of claim 21 wherein said method further comprises:
receiving a query; and
determining one or more levels that will be accessed by that query, and also determining the level indicators associated with the one or more levels that will be accessed by the query to provide the level indicators of the subset,
wherein said displaying said visual indicator is performed for each query.

33. The article of manufacture of claim 21 wherein said method further comprises:
receiving a plurality of queries;
for each query, determining one or more levels accessed by that query;
in response to activating a record operation, storing the queries and the levels accessed by that query; and
wherein said displaying said visual indicator is performed in response to activating a playback operation such that the queries and the levels accessed by the queries are sequentially retrieved, the level indicators associated with the levels accessed by the query are determined to provide the level indicators of the subset for each query, and said displaying said visual indicator is performed for each query.

34. An apparatus for performing a method of visualizing a multidimensional model, comprising:
a processor; and
a memory storing one or more instructions that:
retrieve data describing a multidimensional model comprising a plurality of groups, each group having one or more levels, the levels having a hierarchical order;
display a plurality of sets comprising one or more level indicators, each set being side-by-side to at least one other set, each set being associated with one group of the plurality of groups, the one or more level indicators of each set being associated with the one or more levels of the associated group, respectively, the one or more level indicators of each set being displayed in accordance with the hierarchical order of their associated levels; and
display a visual indicator associated with a subset comprising one or more level indicators of each set.

35. The apparatus of claim 34 wherein said one or more instructions also:
display an any-level associated with each set.

36. The apparatus of claim 34 wherein said one or more instructions also:
when said visual indicator is activated, determine levels associated with the level indicators of the subset, and display additional information regarding the levels associated with the subset.

37. The apparatus of claim 34 wherein said one or more instructions also:
display a line connecting the level indicators of each set, the line of each set being separate, wherein each line corresponds to a lateral edge of a prism to provide a three-dimensional representation.

38. The apparatus of claim 34 wherein each displayed set corresponds to a lateral edge of a prism, the subset comprises one level indicator from each set, wherein said one or more instructions that display said visual indicator display one or more lines that connect each level indicator of the subset along one or more lateral faces of the prism.

39. The apparatus of claim 37 wherein the subset comprises a plurality of level indicators of at least one set.

40. The apparatus of claim 37 wherein said one or more instructions also:
rotate the three-dimensional representation.
